(19) United States
(12) Patent Application Publication
(10) Pub. No.: US 2026/0148224 A1
(43) Pub. Date: May 28, 2026

(54) GENERATING SESSION KEYS FOR SMART WALLETS

(71) Applicant: Coinbase, Inc., Oakland, CA (US)

(72) Inventors: Lukas Sebastian Rosario, New York City, NY (US); Conner Li Swenberg, Brooklyn, NY (US)

(21) Appl. No.: 18/963,317

(22) Filed: Nov. 27, 2024

(51) Int. Cl. G06Q 20/36; G06Q 20/38

(52) U.S. Cl. CPC G06Q 20/367; G06Q 20/3829; G06Q 20/389

(57) ABSTRACT

Methods, systems, and devices for digital token management are described. Techniques described herein may enable the generation of a key pair associated with the application that is temporarily valid without prompting the user to authenticate each transaction individually. For example, the user may validate a key pair to be used for transactions for a period of time, for an amount of crypto token, for a quantity of transactions, and the like. Accordingly, the user may perform purchases using the key pair without exiting the application. In some examples, the key pair may be generated by the application or by an SDK associated with a blockchain wallet application. The key pair may be signed by each of the user, the client application, and one or more on-chain smart contracts, which may prevent the key pair from being used for purchases that are not approved by the user.

### FIELD OF TECHNOLOGY

The present disclosure relates generally to data management, including techniques for generating session keys for smart wallets.

### BACKGROUND

Blockchains and related technologies may be employed to support recordation of ownership of digital assets, such as cryptocurrencies, fungible tokens, non-fungible tokens (NFTs), and the like. Generally, peer-to-peer networks support transaction validation and recordation of transfer of such digital assets on blockchains. Various types of consensus mechanisms may be implemented by the peer-to-peer networks to confirm transactions and to add blocks of transactions to the blockchain networks. Example consensus mechanisms include the proof-of-work consensus mechanism implemented by the Bitcoin network and the proof-of-stake mechanism implemented by the Ethereum network. Some nodes of a blockchain network may be associated with a digital asset exchange, which may be accessed by users to trade digital assets or trade a fiat currency for a digital asset.

### BRIEF DESCRIPTION OF THE DRAWINGS

FIG. 1 illustrates an example of a computing environment that supports generating session keys for smart wallets in accordance with aspects of the present disclosure.

FIG. 2 shows an example of a block diagram that supports generating session keys for smart wallets in accordance with aspects of the present disclosure.

FIG. 3 shows an example of a process flow that supports generating session keys for smart wallets in accordance with aspects of the present disclosure.

FIG. 4 shows an example of a process flow that supports generating session keys for smart wallets in accordance with aspects of the present disclosure.

FIG. 5 shows an example of a process flow that supports generating session keys for smart wallets in accordance with aspects of the present disclosure.

FIG. 6 shows a block diagram of an apparatus that supports generating session keys for smart wallets in accordance with aspects of the present disclosure.

FIG. 7 shows a block diagram of a token management interface that supports generating session keys for smart wallets in accordance with aspects of the present disclosure.

FIG. 8 shows a diagram of a system including a device that supports generating session keys for smart wallets in accordance with aspects of the present disclosure.

FIG. 9 shows a block diagram of an apparatus that supports generating session keys for smart wallets in accordance with aspects of the present disclosure.

FIG. 10 shows a block diagram of a client application that supports generating session keys for smart wallets in accordance with aspects of the present disclosure.

FIG. 11 shows a diagram of a system including a device that supports generating session keys for smart wallets in accordance with aspects of the present disclosure.

FIGS. 12 and 13 show flowcharts illustrating methods that support generating session keys for smart wallets in accordance with aspects of the present disclosure.

### DETAILED DESCRIPTION

A user of a blockchain wallet application may use crypto tokens to complete one or more purchases or transfers associated with an application that is external to the blockchain wallet application. For example, the user may transfer the crypto token from a blockchain wallet associated with the user to a wallet address associated with the application. In some examples, however, the user may be prompted to leave the application for each transfer. For example, the user may access the blockchain wallet application for each purchase to authenticate broadcasting of one or more messages to transfer the crypto token, which may result in relatively worse user experience as compared to purchases that may be completed without leaving the application. In the context of a gaming application, for example, this requirement to repeatedly access the blockchain wallet application to authenticate and sign transactions may significantly hinder user experience and may also be associated with computing resource overhead as the client device may be required to switch application contexts and generate, store, and communicate messages to a blockchain network or a wallet application backend.

Accordingly, techniques described herein may enable the generation of a key pair to be associated with the application that is temporarily valid without prompting the user to authenticate each transaction individually (e.g., a session key). For example, the user may validate the key pair to be used for transactions for a specified period of time, for a specified amount of crypto token, for a specified quantity of transactions, and the like. Accordingly, the user may execute transfers using the key pair without exiting the application or switching to the blockchain wallet application, which may result in relatively improved user experience. Additionally, the resource overhead associated with repeatedly using the blockchain wallet application may be reduced, as the client device may not switch application contexts, and may avoid repeatedly generating, storing, and transmitting messages for each transfer. In some examples, the key pair may be generated by the application or by a software development kit (SDK) associated with the blockchain wallet application (e.g., a custodial token platform). The user may sign the key pair (e.g., using a key pair associated with the blockchain wallet application) and associated permissions that the user grants for use of the key pair, which may prevent the key pair from being used for purchases that are not approved by the user.

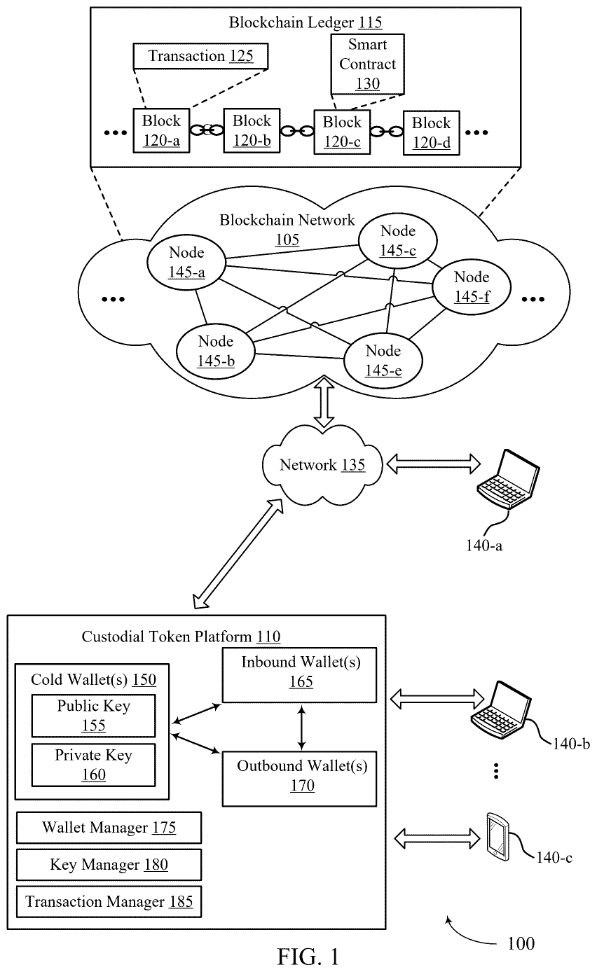

FIG. 1 illustrates an example of a computing environment 100 that supports generating session keys for smart wallets in accordance with aspects of the present disclosure. The computing environment 100 may include a blockchain network 105 that supports a blockchain ledger 115, a custodial token platform 110, and one or more computing devices 140, which may be in communication with one another via a network 135.

The network 135 may allow the one or more computing devices 140, one or more nodes 145 of the blockchain network 105, and the custodial token platform 110 to communicate (e.g., exchange information) with one another. The network 135 may include aspects of one or more wired networks (e.g., the Internet), one or more wireless networks (e.g., cellular networks), or any combination thereof. The network 135 may include aspects of one or more public networks or private networks, as well as secured or unsecured networks, or any combination thereof. The network 135 also may include any quantity of communications links and any quantity of hubs, bridges, routers, switches, ports or other physical or logical network components.

Nodes 145 of the blockchain network 105 may generate, store, process, verify, or otherwise use data of the blockchain ledger 115. The nodes 145 of the blockchain network 105 may represent or be examples of computing systems or devices that implement or execute a blockchain application or program for peer-to-peer transaction and program execution. For example, the nodes 145 of the blockchain network 105 support recording of ownership of digital assets, such as cryptocurrencies, fungible tokens, non-fungible tokens (NFTs), and the like, and changes in ownership of the digital assets. The digital assets may be referred to as tokens, coins, crypto tokens, or the like. The nodes 145 may implement one or more types of consensus mechanisms to confirm transactions and to add blocks (e.g., blocks 120-a, 120-b, 120-c, and so forth) of transactions (or other data) to the blockchain ledger 115. Example consensus mechanisms include a proof-of-work consensus mechanism implemented by the Bitcoin network and a proof-of-stake consensus mechanism implemented by the Ethereum network.

When a device (e.g., the computing device 140-a, 140-b, or 140-c) associated with the blockchain network 105 executes or completes a transaction associated with a token supported by the blockchain ledger, the nodes 145 of the blockchain network 105 may execute a transfer instruction that broadcasts the transaction (e.g., data associated with the transaction) to the other nodes 145 of the blockchain network 105, which may execute the blockchain application to verify the transaction and add the transaction to a new block (e.g., the block 120-d) of a blockchain ledger (e.g., the blockchain ledger 115) of transactions after verification of the transaction. Using the implemented consensus mechanism, each node 145 may function to support maintaining an accurate blockchain ledger 115 and prevent fraudulent transactions.

The blockchain ledger 115 may include a record of each transaction (e.g., a transaction 125) between wallets (e.g., wallet addresses) associated with the blockchain network 105. Some blockchains may support smart contracts, such as smart contract 130, which may be an example of a sub-program that may be deployed to the blockchain and executed when one or more conditions defined in the smart contract 130 are satisfied. For example, the nodes 145 of the blockchain network 105 may execute one or more instructions of the smart contract 130 after a method or instruction defined in the smart contract 130 is called by another device. In some examples, the blockchain ledger 115 is referred to as a blockchain distributed data store.

A computing device 140 may be used to input information to or receive information from the custodial token platform 110, the blockchain network 105, or both. For example, a user of the computing device 140-a may provide user inputs via the computing device 140-a, which may result in commands, data, or any combination thereof being communicated via the network 135 to the custodial token platform 110, the blockchain network 105, or both. Additionally, or alternatively, a computing device 140-a may output (e.g., display) data or other information received from the custodial token platform 110, the blockchain network 105, or both. A user of a computing device 140-a may, for example, use the computing device 140-a to interact with one or more user interfaces (e.g., graphical user interfaces (GUIs)) to operate or otherwise interact with the custodial token platform 110, the blockchain network 105, or both.

A computing device 140 and/or a node 145 may be a stationary device (e.g., a desktop computer or access point) or a mobile device (e.g., a laptop computer, tablet computer, or cellular phone). In some examples, a computing device 140 and/or a node 145 may be a commercial computing device, such as a server or collection of servers. And in some examples, a computing device 140 and/or a node 145 may be a virtual device (e.g., a virtual machine).

Some blockchain protocols may have layer two and layer two functionality, and each layer may support or utilize different tokens. Layer one may refer to the underlying main blockchain architecture, and layer one solutions are improvements directly integrated into the codebase of a cryptocurrency's main blockchain. Layer one solutions, on the other hand, are built on top of layer one and may interact with the main blockchain but have their own architecture. Layer two solutions may support offload of processing from the main blockchain (layer one) to improve scalability and speed while retaining the robust security of the main chain. Additionally, smart contracts implemented on the blockchain networks may support different types of tokens, and the code of the smart contracts may control how tokens are spent, who can spend the tokens, and other conditions for transfer. Additionally, one or more smart contracts may support a decentralized application (“Dapp”) that facilitate various types of functionality. Accordingly, various types of tokens may be supported by a blockchain network.

The custodial token platform 110 may support exchange or trading of digital assets, fiat currencies, or both by users of the custodial token platform 110. The custodial token platform 110 may be accessed via website, web application, or applications that are installed on the one or more computing devices 140. The custodial token platform 110 may be configured to interact with one or more types of blockchain networks, such as the blockchain network 105, to support digital asset purchase, exchange, deposit, and withdrawal.

For example, users may create accounts associated with the custodial token platform 110 such as to support purchasing of a digital asset via a fiat currency, selling of a digital asset via fiat currency, or exchanging or trading of digital assets. A key management service (e.g., a key manager) of the custodial token platform 110 may create, manage, or otherwise use private keys that are associated with user wallets and internal wallets. For example, if a user wishes to withdraw a token associated with the user account to an external wallet address, key manager 180 may sign a transaction associated with a wallet of the user, and broadcast the signed transaction to nodes 145 of the blockchain network 105, as described herein. In some examples, a user does not have direct access to a private key associated with a wallet or account supported or managed by the custodial token platform 110. As such, user wallets of the custodial token platform 110 may be referred to non-custodial wallets or non-custodial addresses.

The custodial token platform 110 may create, manage, delete, or otherwise use various types of wallets to support digital asset exchange. For example, the custodial token platform 110 may maintain one or more internal cold wallets 150. The internal cold wallets 150 may be an example of an offline wallet, meaning that the cold wallet 150 is not directly coupled with other computing systems or the network 135 (e.g., at all times). The cold wallet 150 may be used by the custodial token platform 110 to ensure that the custodial token platform 110 is secure from losing assets via hacks or other types of unauthorized access and to ensure that the custodial token platform 110 has enough assets to cover any potential liabilities. The one or more cold wallets 150, as well as other wallets of the blockchain network 105 may be implemented using public key cryptography, such that the cold wallet 150 is associated with a public key 155 and a private key 160. The public key 155 may be used to publicly transact via the cold wallet 150, meaning that another wallet may enter the public key 155 into a transaction such as to move assets from the wallet to the cold wallet 150. The private key 160 may be used to verify (e.g., digitally sign) transactions that are transmitted from the cold wallet 150, and the digital signature may be used by nodes 145 to verify or authenticate the transaction. Other wallets of the custodial token platform 110 and/or the blockchain network 105 may similarly use aspects of public key cryptography.

The custodial token platform 110 may also create, manage, delete, or otherwise use inbound wallets 165 and outbound wallets 170. For example, a wallet manager 175 of the custodial token platform 110 may create a new inbound wallet 165 for each user or account of the custodial token platform 110 or for each inbound transaction (e.g., deposit transaction) for the custodial token platform 110. In some examples, the custodial token platform 110 may implement techniques to move digital assets between wallets of the digital asset exchange platform. Assets may be moved based on a schedule, based on asset thresholds, liquidity requirements, or a combination thereof. In some examples, movements or exchanges of assets internally to the custodial token platform 110 may be “off-chain” meaning that the transactions associated with the movement of the digital asset are not broadcast via the corresponding blockchain network (e.g., blockchain network 105). In such cases, the custodial token platform 110 may maintain an internal accounting (e.g., ledger) of assets that are associated with the various wallets and/or user accounts.

As used herein, a wallet, such as inbound wallets 165 and outbound wallets 170 may be associated with a wallet address, which may be an example of a public key, as described herein. The wallets may be associated with a private key that is used to sign transactions and messages associated with the wallet. A wallet may also be associated with various user interface components and functionality. For example, some wallets may be associated with or leverage functionality for transmitting crypto tokens by allowing a user to enter a transaction amount, a receiver address, etc. into a user interface and clicking or activating a UI component such that the transaction is broadcast via the corresponding blockchain network via a node (e.g., a node 145) associated with the wallet. As used herein, “wallet” and “address” may be used interchangeably.

In some cases, the custodial token platform 110 may implement a transaction manager 185 that supports monitoring of one or more blockchains, such as the blockchain ledger 115, for incoming transactions associated with addresses managed by the custodial token platform 110 and creating and broadcasting on-blockchain transactions when a user or customer sends a digital asset (e.g., a withdrawal). For example, the transaction manager 185 may monitor the addressees of the customers for transfer of layer one or layer two tokens supported by the blockchain ledger 115 to the addresses managed by the custodial token platform 110. As another example, when a user is withdrawing a digital asset, such as a layer one or layer two token, to an external wallet (e.g., an address that is not managed by the custodial token platform 110 or an address for which the custodial token platform 110 does not have access to the associated private key), the transaction manager 185 may create and broadcast the transaction to one or more other nodes 145 of the blockchain network 105 in accordance with the blockchain application associated with the blockchain network 105. As such, the transaction manager 185, or an associated component of the custodial token platform 110 may function as a node 145 of the blockchain network 105.

As described herein, the custodial token platform may implement and support various wallets including the inbound wallets 165, the outbound wallets 170, and the cold wallets 150. Further, the custodial token platform 110 may implement techniques to maintain and manage balances of the various wallets. In some examples, the balances of the various wallets are configured to support security and liquidity. For example, the custodial token platform 110 may implement transactions that move crypto tokens between the inbound wallets 165 and the outbound wallets 170. These transactions may be referred to as “flush” transactions and may occur on a periodic or scheduled basis.

As described herein, various transactions may be broadcast to the blockchain ledger 115 to cause transfer of crypto tokens, to call smart contracts, to deploy smart contracts etc. In some examples, these transactions may also be referred to as messages. That is, the custodial token platform 110 may broadcast a message to the blockchain network 105 to cause transfer of tokens between wallets managed by the custodial token platform 110 to an external wallet, to deploy a smart contract (e.g., a self-executing program), or to call a smart contract.

In some examples of the computing environment 100, a user may open a smart wallet associated with the custodial token platform 110. The smart wallet may be a wallet associated with a blockchain address via which the user may transfer crypto tokens as described herein. In some examples, the smart wallet may be configured to connect to a plurality of client applications (e.g., Dapps). For example, the client applications may install an SDK associated with the custodial token platform 110 that may enable connection to the smart wallet. The user may accordingly use funds of the smart wallet to perform one or more purchases associated with the one or more client applications. Smart wallets, as described herein, may be passkey-based wallets. A passkey may be an example of a digital credential bound to a user account, such as an email account, or a hardware device and a website or application, such as a client application or a blockchain address application as described herein. In other words, passkeys may be associated with user accounts or hardware devices and may be uniquely bound to a domain. For example, passkeys may be stored at a location that is associated with the user account or hardware device (e.g., in a secure enclave, a cloud, on the hardware device, etc.). Additionally, passkeys may be usable on the domain that they are bound to (e.g., and not on other domains). Creating a smart wallet may involve creating a passkey. For example, a user may create a passkey bound to a user account (e.g., of the client application, or a different account) and bound to a domain of the client application. The passkey may be used to encrypt a private key. Additionally, smart wallets may not involve recovery phrases (e.g., recovery phrases for externally owned account (EOA) wallets). Examples are described herein with respect to the smart wallet being associated with the custodial token platform 110 and/or applications utilizing an SDK associated with the custodial token platform. It should be understood, however, that the techniques described herein do not require the utilization of services provided by the custodial token platform 110 or similar platforms.

In some examples, one or more devices of the computing environment 100 may support generation of a key pair (e.g., a temporary key pair) associated with a client application (e.g., a Dapp) that is temporarily valid without prompting the user to authenticate each transaction individually. For example, the user may validate the key pair to be used for transactions for a specified period of time, for a specified amount of crypto token, for a specified quantity of transactions, and the like. Accordingly, the user may perform purchases using the key pair without exiting the application, which may result in relatively improved user experience and reduced computing resource overhead at a computing device (e.g., computing device 140). In some examples, the key pair may be generated by the application or by a SDK associated with a blockchain wallet application (e.g., the custodial token platform 110). The key pair may be validated (e.g., signed) by each of the user, the client application, and one or more on-chain smart contracts, which may prevent the key pair from being used for purchases that are not approved by the user.

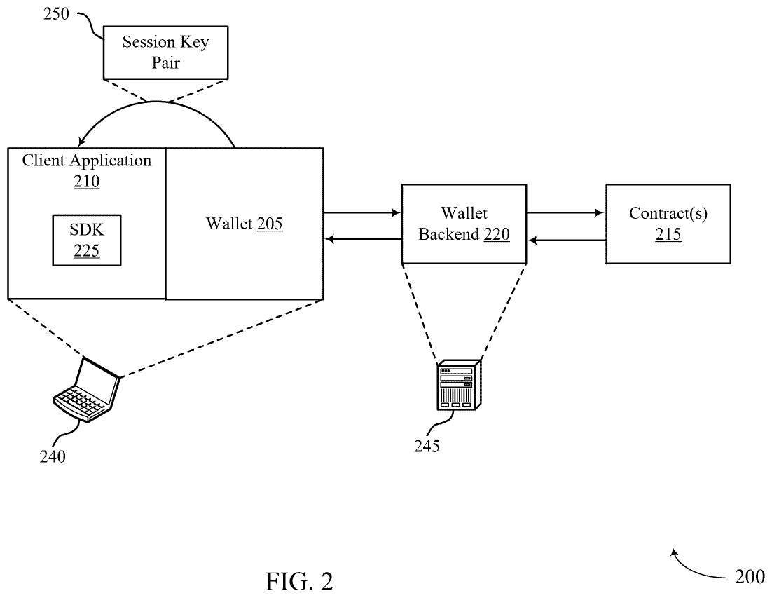

FIG. 2 shows an example of a block diagram 200 that supports generating session keys for smart wallets in accordance with aspects of the present disclosure. The block diagram 200 may implement or may be implemented by aspects of the computing environment 100. For example, the block diagram 200 may be implemented by a custodial token platform 110 and a user device 140 as described with reference to FIG. 1.

In some examples of the block diagram 200, a user may access a user device 240 (e.g., a computing device 104 of FIG. 1) to generate a wallet 205 (e.g., a smart wallet) associated with a blockchain address of the user that may be configured to connect to one or more applications. For example, the user may connect the wallet 205 to a client application 210 (e.g., a Dapp) such that the user may perform one or more transactions in the client application 210 to transfer crypto token from the wallet 205 to one or more blockchain addresses associated with the client application 210. In some examples, the wallet 205 may interface with the client application 210 via an SDK 225 installed by the client application 210 that is associated with the blockchain wallet application that supports the wallet 205. In some cases, the SDK 225, the wallet 205, and/or a wallet backend 220 may be associated with or supported by the custodial token platform 110 of FIG. 1. Accordingly, various client applications, such as the client application 210 may install or leverage the SDK 225 to support techniques described herein and other smart wallet functionality.

In some examples, to perform such transactions without the techniques described herein, the client application 210 may prompt the user to switch contexts from the client application 210 to launch a blockchain wallet application to authorize each transaction on the user device 240. Such techniques may result in a relatively worse experience of the user due to switching between applications to perform transactions. In some scenarios, the bad user experiences are exacerbated. For example, if the client application is a gaming application, and the client application requests a transaction each time the user performs some action in the game, then the user may be required to switch application contexts and approve the transaction in the blockchain wallet application for each action. In such cases, the game may need to be paused. Repeatedly switching application contexts may also be associated with increased computing resource overhead, as the user device 240 may use memory and other resources to switch application contexts, generate transactions, process transactions, and transmit messages associated with broadcasting the transactions via a blockchain network.

Accordingly, in some implementations, the user may authorize use, by the client application 210, of a temporary key pair (e.g., session key pair 250) that may be used to authorize transfer of crypto token between the blockchain address of the user (e.g., the wallet 205) and the one or more blockchain addresses associated with the client application 210. The client application 210 may accordingly use an app-owned key to sign user operations for a user account (e.g., an account associated with the wallet 205). In some examples, use of the temporary key pair may be limited by one or more permissions (e.g., parameters) set by the user. For example, the user may authorize use of the temporary key pair up to an amount of crypto token, for a period of time (e.g., until a specified timestamp), according to a periodicity (e.g., once a week), for a specified type of crypto token, and/or for a quantity of transactions. The permissions may further include one or more addresses of contracts (e.g., smart contracts) for which the temporary key pair may be used to call functions. In some examples, the user may revoke the permissions such that the client application 210 may not use the temporary key pair.

In some aspects, the client application (e.g., and/or the SDK 225) may generate and sign the temporary key pair. For example, the client application 210 may transmit a request to the SDK 225 to generate the temporary key pair. The client application 210 may display a request for the user to enable the permissions that may allow the client application 210 to perform transactions on behalf of the user using the temporary key pair. In some examples, the request to the user may include a public key of the temporary key pair.

The user may authorize use of the temporary key pair by signing a permissions payload (e.g., indicating the parameters associated with the permissions) using a private key associated with the blockchain address (e.g., the wallet 205) of the user. In the case of the wallet 205 being a smart wallet, the private key may be associated with or accessed via a passkey. The wallet 205 may provide the signed permissions payload to a wallet backend 220 of the wallet (e.g., a wallet server 245). The wallet backend 220 may store the signed permissions payload and indicate to the client application 210 (e.g., via the SDK 225) that the user has provided an authorization for use of the temporary keypair. For example, the wallet backend 220 may provide the signed permissions payload to the client application 210. The wallet server 245 may be an example of or represent one or more servers that support other services, such as service implemented by the custodial token platform 110 of FIG. 1.

To initiate a transaction using the temporary key pair, the client application 210 may transmit, to the wallet backend 220, a request for the wallet backend 220 to prepare one or more calls for the transaction. The wallet backend 220 may prepare the calls in response to the request and may provide, to the client application 210, the prepared calls and a hash value associated with the transaction. The client application 210 may sign the hash value (e.g., using a private key associated with the temporary key pair) and may return the prepared calls and the signed hash value as a request for the wallet backend 220 to broadcast one or more messages to complete the transaction. In some examples (e.g., if the SDK 225 generates the temporary key pair), the SDK 225 may sign the hash value using the private key of the temporary key pair on behalf of the client application 210.

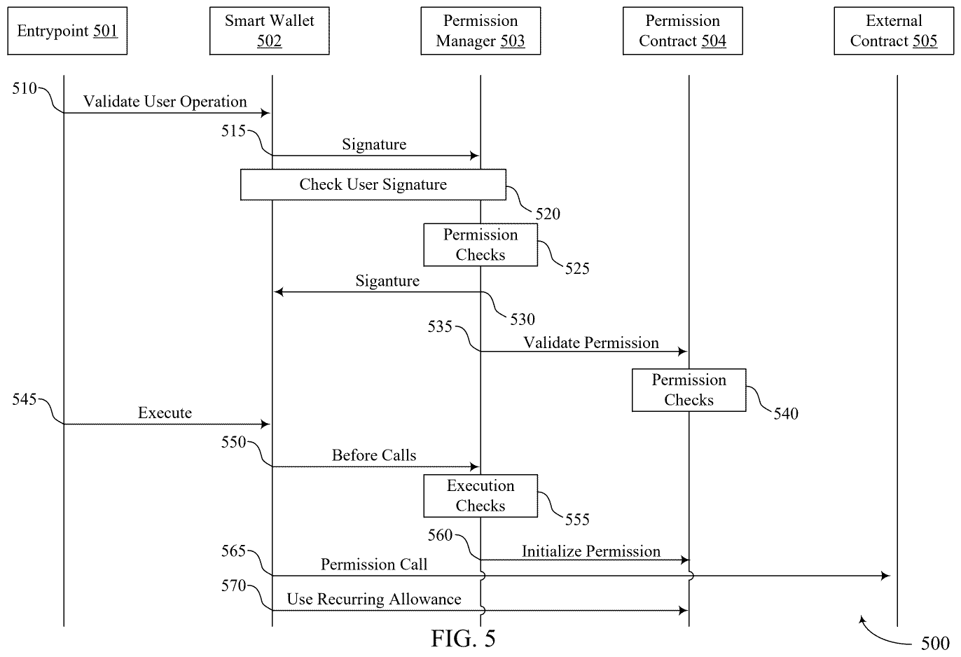

The wallet backend 220 may perform one or more verifications of the request. For example, the wallet backend 220 may call one or more contracts 215 (e.g., a permissions manager, a permissions contract) to perform verification checks of the request (e.g., on-chain). The verification checks may confirm that the requested transaction is in accordance with the parameters of the permissions payload signed by the user. Such techniques are described in further detail with reference to FIG. 5.

In response to the request passing the verification checks, the wallet backend 220 may cosign the request. The wallet backend 220 may submit the request to one or more entities (e.g., a transaction bundler) that may submit the requested transaction on-chain. For example, the wallet backend 220 may broadcast one or more messages that cause transfer of the crypto token between the blockchain address associated with the user (e.g., the wallet 205) and the one or more blockchain addresses associated with the client application 210.

If the request does not pass the verification checks, the wallet backend 220 may not cosign the request. The amount of crypto token may accordingly not be transferred between the blockchain address associated with the user and the one or more blockchain addresses associated with the client application 210. In such examples, the batch of calls requested by the client application 210 may be reverted.

As described herein, the wallet 205 may be an example of a smart wallet, and the private key of the smart wallet may be uniquely bound to a domain, such as the client application 210. The client application 210 may therefore use and access the private key (e.g., without use of the SDK 225). That is, the smart wallet may be uniquely configured to interact with the client application 210. Additionally, or alternatively, the client application 210 may leverage the SDK 225 to perform various services, such as key management. In some cases, other types of client applications may also leverage the SDK 225 for services such as key management, and as such, the smart wallet may also be used with other client applications due to the use of a common SDK or different instances of the SDK 225.

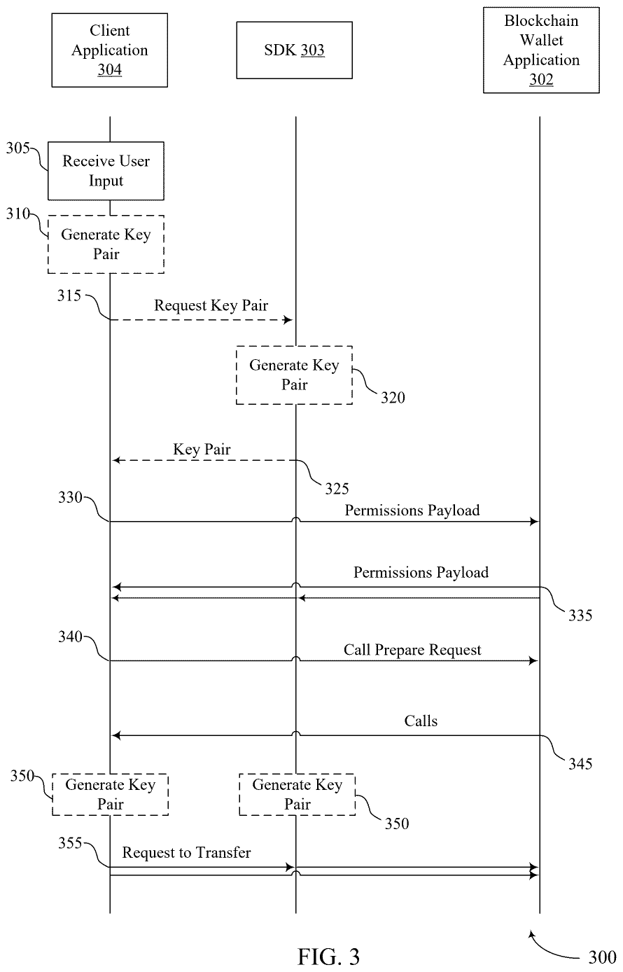

FIG. 3 shows an example of a process flow 300 that supports generating session keys for smart wallets in accordance with aspects of the present disclosure. The process flow 300 may implement or may be implemented by aspects of the computing environment 100 or the block diagram 200. For example, the process flow 300 may be implemented by a user devices 140 and custodial token platforms 110 as described with reference to FIG. 1.

In the following description of the process flow 300, the operations between a blockchain wallet application 302, a SDK 303, and a client application 304 may occur in a different order than the example order shown and, in some examples, may be performed by one or more different devices other than those shown as examples. Some operations also may be omitted from the process flow 300, and other operations may be added to the process flow 300. Further, although some operations or signaling may be shown to occur at different times for discussion purposes, these operations may actually occur at the same time. In some examples, the client application 304 and the SDK 303 may be portions of or implemented as a full client application. That is, the full client application may include the client application 304 which has installed and leverages the SDK 303 for various services. In such cases, the client application 304 may be an example of a website or web-services that uses the SDK 303 for various services. In some examples, the SDK 303 is configured for interactions with the blockchain wallet application 302, such as a front-end of the blockchain wallet application, a backend of the blockchain wallet application, or both.

At 305, the client application 304 may receive a user input to provide permissions to the client application to transfer an amount of crypto token between a blockchain address of a user (e.g., associated with a blockchain wallet application 302) and one or more blockchain addresses associated with the client application 304. For example, the user may click or otherwise activate a user interface component at the client application 304 that initiates the permissions flow described herein.

The client application 304 may obtain a temporary key pair associated with transferring the amount of crypto token between the blockchain address of the user and the one or more blockchain addresses associated with the client application 304. For example, at 310, the client application 304 may generate the temporary key pair via a key service of the client application. That is, the client application 304 may facilitate generation and management of the temporary key pair. Additionally, or alternatively, the client application may leverage the SDK 303 for generation and management of the key pair. For example, at 315, the client application 304 may transmit a request to an SDK 303 (e.g., an SDK associated with the blockchain wallet application 302 and installed by the client application 304) to generate the temporary key pair. At 320, the SDK 303 may generate and store the temporary key pair. At 325, client application 304 may receive the temporary key pair from the SDK 303.

At 330, the client application 304 may transmit a permissions payload to the blockchain wallet application 302. The permissions payload may include one or more parameters defining usage of a temporary key pair by a client application 304. In some examples, the one or more parameters may include a duration for which the temporary key pair is valid, a threshold amount of crypto tokens that are approved for transfer, the one or more blockchain addresses for which transfer of crypto tokens is approved, a threshold quantity of requests to transfer the crypto tokens between the first blockchain address and the one or more second blockchain addresses that are approved, and/or a type of crypto token that is approved for transfer. At 335, the client application may receive a signed permissions payload from the blockchain wallet application 302 and/or from the SDK 303. The permissions payload may be signed (e.g., by the user) using a private key associated with the blockchain address of the user. In some examples, a backend service of the blockchain wallet application 302 may store the permissions payload.

At 340, the client application 304 may transmit, to one or more servers associated with the blockchain wallet application 302 (e.g., wallet backend), a request to prepare one or more calls associated with the request to transfer the amount of crypto token. In response, the backend of the blockchain wallet application 302 may prepare the calls (e.g., build userOp) and hash the prepared calls. At 345, the client application 304 may receive the prepared calls and a hash value associated with the prepared calls. At 350, the client application 304, the SDK 303, or both may sign the prepared calls, the hash value, or both with a stored key (e.g., the private key of the temporary key pair).

At 355, the client application 304 may transmit, to the one or more servers (e.g., the wallet backend), a request to transfer the amount of crypto token between the blockchain address associated with the user and the one or more blockchain addresses associated with the client application 304. For example, the client application 304 may transmit the request to the SDK 303, and the SDK 303 may transmit the request to the one or more servers of the blockchain wallet application 302. The one or servers may broadcast the transaction via the blockchain network such as to cause the transfer.

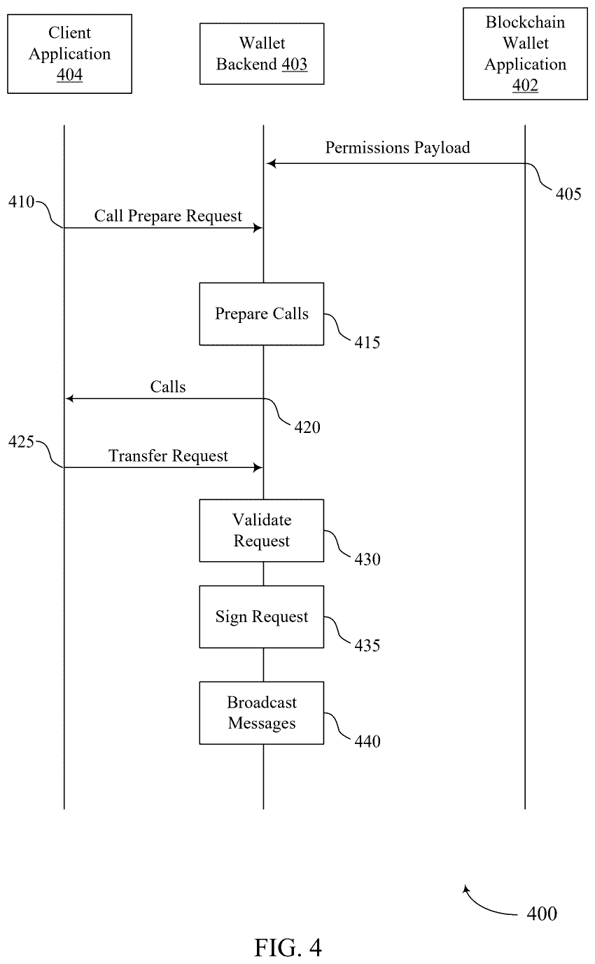

FIG. 4 shows an example of a process flow 400 that supports generating session keys for smart wallets in accordance with aspects of the present disclosure. The process flow 400 may implement or may be implemented by aspects of the computing environment 100, the block diagram 200, or the process flow 300. For example, the process flow 400 may be implemented by a user devices 140 and custodial token platforms 110 as described with reference to FIG. 1.

In the following description of the process flow 400, the operations between a blockchain wallet application 402, a wallet backend 403, and a client application 404 may occur in a different order than the example order shown and, in some examples, may be performed by one or more different devices other than those shown as examples. Some operations also may be omitted from the process flow 400, and other operations may be added to the process flow 400. Further, although some operations or signaling may be shown to occur at different times for discussion purposes, these operations may actually occur at the same time. The client application may encapsulate a client application (e.g., a website or webservice), such as client application 304 of FIG. 3, and an SDK, such as the SDK 303 of FIG. 3. The wallet backend 403 may represent one or more servers that support the blockchain wallet application 402.

At 405, the wallet backend 403 may receive a permissions payload from the blockchain wallet application 402. The permissions payload may include one or more parameters defining usage of a temporary key pair by a client application 404. The temporary key pair may be associated with transfer of an amount of crypto token from a blockchain address of a user (e.g., a smart wallet associated with the wallet backend 403 and the blockchain wallet application 402) to one or more blockchain addresses associated with the client application 404. The permissions payload may be signed (e.g., based on input by the user) using a private key associated with the blockchain address (e.g., the smart wallet address) of the user. In some examples, the one or more parameters may include a duration for which the temporary key pair is valid, a threshold amount of crypto tokens that are approved for transfer, the one or more blockchain addresses for which transfer of crypto tokens is approved, a threshold quantity of requests to transfer the crypto tokens between the first blockchain address and the one or more second blockchain addresses that are approved, and/or a type of crypto token that is approved for transfer.

At 410, the wallet backend 403 may receive, from the client application 404, a request to prepare one or more calls associated with a request to transfer the amount of crypto token. At 415, the wallet backend 403 may prepare the one or more calls (e.g., based on receiving data associated with the blockchain address of the user). For example, the wallet backend 403 may transmit one or more requests to obtain (e.g., from one or more external devices, such as a paymaster), paymaster stub data and/or stub data associated with the blockchain address of the user. At 420, the wallet backend 403 may output the one or more calls to the client application 404.

The client application 404 may sign the one or more calls (e.g., using a private key of the temporary key pair) and provide the signed calls to the wallet backend 403. For example, at 425, the client application 404 may indicate, to the wallet backend 403, a request to transfer an amount of crypto token between the blockchain address of the user and the one or more blockchain addresses associated with the client application 404.

At 430, the wallet backend 403 may validate the request. For example, the wallet backend may execute one or more smart contracts (e.g. on-chain) to validate the request. Such validation techniques are described in further detail with reference to FIG. 5. That is, the wallet backend 403 may broadcast a signed message (e.g., indicating the request) configured to call one or more smart contracts (e.g., permissions contracts) on the blockchain network. The permissions contracts may validate that the permission associated with use of the temporary key pair is not revoked, that the permission is approved by the first blockchain address, that the request to transfer is signed using the private key of the temporary key pair, that one or more messages configured to cause transfer of the amount of the crypto tokens via the blockchain network call one or more allowed addresses on the blockchain network, and/or that the one or more messages include a call to an allowance contract configured to monitor satisfaction of recurring allowances associated with the permissions payload.

The wallet backend 403 may receive an indication that the request is validated (e.g., from the permissions contracts). At 435, the wallet backend 403 may sign the request based on the request being validated. At 440, the wallet backend 403 may broadcast the one or more messages configured to cause transfer of the amount of the crypto tokens via the blockchain network. In some examples, the one or more messages may cause one or more allowance contracts to determine whether the transfer is in accordance with the parameters of the permissions payload (e.g., whether the amount of crypto token exceeds the threshold amount defined by one or more parameters of the permissions payload).

The determination of whether the transfer is in accordance with the parameters of the permissions payload may be an example of recurring accounting. The permissions parameters may allow the client application 404 to request to spend user assets (e.g., crypto tokens) on a recurring basis (e.g., 1 ETH/month).

As applications spend user assets through using this permission, the recurring logic automatically increments and enforces the allowance for the current cycle. Once enough time passes to enter the next cycle, the allowance usage is reset to zero and the application may keep spending up to the same allowance. This design allows users and apps to have reduced friction in approving asset use, while still giving the user control to manage risk and keep asset allowance small upfront. This design is also intuitive for users and can easily support recurring models like subscriptions, automated trading strategies, and payroll.

A spend permission may be defined by 3 values: start time, cycle period, and allowance per cycle. The start time and cycle period set a deterministic schedule infinitely into the future for when allowances reset to zero for the next cycle.

The following is an example of the first few cycles for a spend permission:

$$[ start , start + period - 1 ]$$

$$[ start + period , start + 2 * period - 1 ]$$

$$[ start + 2 * period , start + 3 * period - 1 ]$$

This example follows the general form for the nth cycle's time range: [start+(n−1)*period, start+n*period−1] with first n=1.

When a new spend of a spend permission is attempted, the contract(s) first determine what the current cycle's usage is. If the current time falls within the cycle of last stored use, the contract checks if this new usage will exceed the allowance. If the current time exceeds the cycle of last stored use, that means the spend is in a new cycle and should reset the allowance to zero and then add a new attempted spend. By leveraging a single storage slot, gas cost does not scale with usage, keeping it efficient.

FIG. 5 shows an example of a process flow 500 that supports generating session keys for smart wallets in accordance with aspects of the present disclosure. The process flow 500 may implement or may be implemented by aspects of the computing environment 100, the block diagram 200, the process flow 300, or the process flow 400. For example, the process flow 500 may be implemented by an entrypoint 501, a smart wallet 502, a permission manager 503, a permission contract 504, and an external contract 505, which may be examples of smart contracts 130 as described with reference to FIG. 1. In some examples, the operations of the process flow 500 may be performed on-chain as described with reference to FIG. 1. The process flow 500 may illustrate example on-chain operations for validating a request to transfer received from a wallet application based on communications from a client application (e.g., client application 210) and/or an SDK (e.g., SDK 225) of the client application using a temporary key pair or session key as described herein. The operations of the process flow 500 may be performed such as to validate signatures on the request, validate the permissions associated with the temporary key pair, or a combination thereof.

In the following description of the process flow 500, the operations between the entrypoint 501, the smart wallet 502, the permission manager 503, the permission contract 504, and the external contract 505 may occur in a different order than the example order shown and, in some examples, may be performed by one or more different devices other than those shown as examples. Some operations also may be omitted from the process flow 500, and other operations may be added to the process flow 500. Further, although some operations or signaling may be shown to occur at different times for discussion purposes, these operations may actually occur at the same time.

At 510, the entrypoint 501 may indicate a request for a smart wallet 502 of a user to transfer an amount of token from the smart wallet 502 to an account associated with the application (e.g., a user operation). For example, the entrypoint 501 may indicate a request for validation of a temporary key pair for use by an application to transfer the amount of token from the smart wallet 502 to an account associated with the application. At 515, the smart wallet 502 may provide a signature associated with the user to a permission manager 503. At 520, the permission manager 503, the smart wallet 502, or both may check the user signature to verify that the user has provided permission for use of the temporary key pair.

At 525, the permission manager 503 may perform one or more permission checks. For example, the permission manager 503 may verify that the user has not revoked permission to use the temporary key pair, that the user has approved the permission to use the temporary key pair, that a private key of the temporary key pair has been used to sign the request, that the request prepends a request to execute one or more calls, and the like. At 530, the permission manager 503 may provide a signature verifying that the permission checks are successful.

At 535, the permission manager 503 may output a request to a permission contract 504 to perform one or more additional permission checks. For example, at 540, the permission contract 504 may verify that the request calls one or more allowed contracts (e.g., within the parameters of the permissions payload) and that the request is following a call enabling the application to use a recurring allowance to transfer the crypto token. In some examples, the entrypoint 501 may receive validation data form the smart wallet 502 indicating that the request has passed the validation checks.

At 545, the entrypoint 501 may indicate that the smart wallet 502 execute one or more transactions in response to verifying the request. For example, the entrypoint 501 may indicate for the smart wallet 502 to output call data indicating for the transactions to be executed to an external contract 505 for execution. At 550, the smart wallet 502 may indicate for the permission manager 503 to perform one or more execution phase checks (e.g., before the call data is sent to the external contract 505). At 555, the permission manager 503 may perform one or more execution phase checks. For example, the permission manager 503 may verify that the permission manager 503 is not paused, that the permission to use the temporary key pair has not expired, that the permission contract 504 is enabled, and that a cosigner (e.g., a wallet backend) has signed the user operation.

At 560, the permission manager 503 may indicate for the permission contract 504 to initialize the permission to use the temporary key pair. At 565, the smart wallet 502 may output the call data indicating that the transactions are to be executed to the external contract 505. The external contract 505 may accordingly execute the transactions to transfer an amount of crypto token from the smart wallet 502 to an account associated with the application. At 570, the smart wallet 502 may indicate that the permission contract 504 may use the recurring allowance to transfer the crypto token (e.g., within a spend limit indicated by the recurring allowance). Accordingly, the smart contracts of the process flow 500 may verify that the user has provided permission to use the temporary key pair, that the user has not revoked permission to use the temporary key pair, and that the call data is requesting an amount of crypto token to be transferred that is within a limitation defined by the recurring allowance.

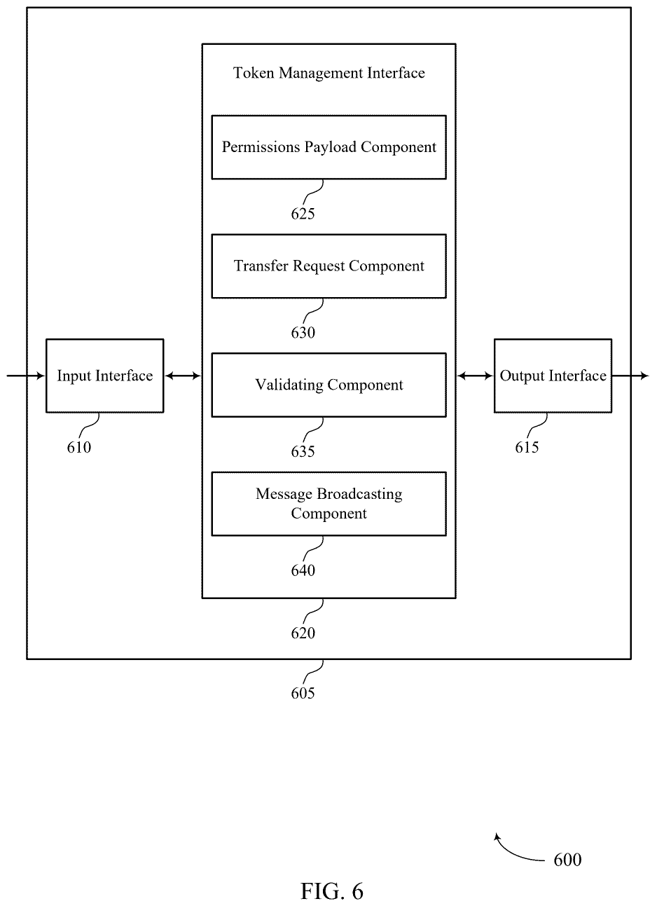

FIG. 6 shows a block diagram 600 of a device 605 that supports generating session keys for smart wallets in accordance with aspects of the present disclosure. The device 605 may include an input interface 610, an output interface 615, and a token management interface 620. The device 605, or one or more components of the device 605 (e.g., the input interface 610, the output interface 615, the token management interface 620), may include at least one processor, which may be coupled with at least one memory, to support the described techniques. Each of these components may be in communication with one another (e.g., via one or more buses).

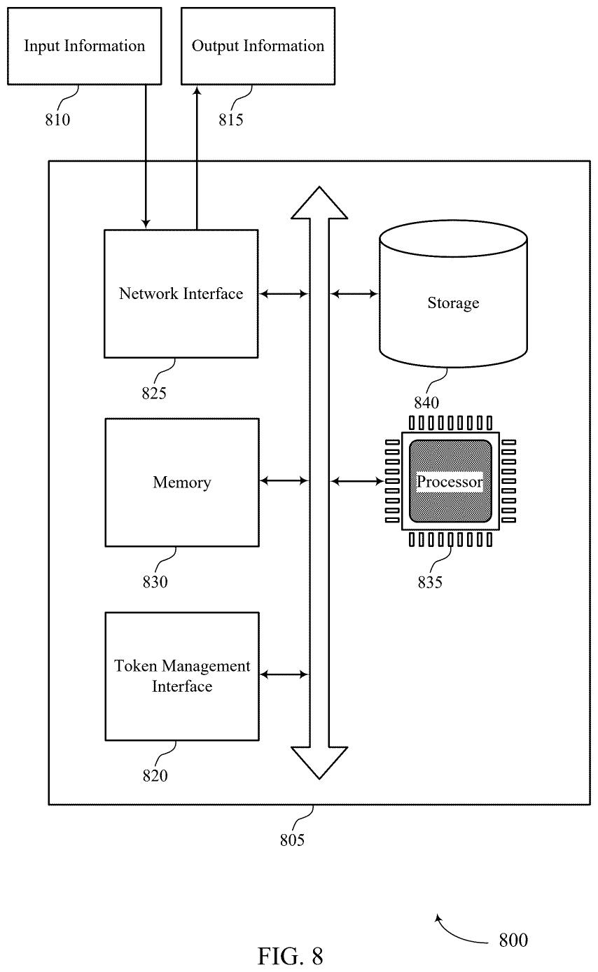

The input interface 610 may manage input signaling for the device 605. For example, the input interface 610 may receive input signaling (e.g., messages, packets, data, instructions, commands, transactions, or any other form of encoded information) from other systems or devices. The input interface 610 may send signaling corresponding to (e.g., representative of or otherwise based on) such input signaling to other components of the device 605 for processing. For example, the input interface 610 may transmit such corresponding signaling to the token management interface 620 to support generating session keys for smart wallets. In some cases, the input interface 610 may be a component of a network interface 825 as described with reference to FIG. 8.

The output interface 615 may manage output signaling for the device 605. For example, the output interface 615 may receive signaling from other components of the device 605, such as the token management interface 620, and may transmit such output signaling corresponding to (e.g., representative of or otherwise based on) such signaling to other systems or devices. In some cases, the output interface 615 may be a component of a network interface 825 as described with reference to FIG. 8.

For example, the token management interface 620 may include a permissions payload component 625, a transfer request component 630, a validating component 635, a message broadcasting component 640, or any combination thereof. In some examples, the token management interface 620, or various components thereof, may be configured to perform various operations (e.g., receiving, monitoring, transmitting) using or otherwise in cooperation with the input interface 610, the output interface 615, or both. For example, the token management interface 620 may receive information from the input interface 610, send information to the output interface 615, or be integrated in combination with the input interface 610, the output interface 615, or both to receive information, transmit information, or perform various other operations as described herein.

The token management interface 620 may support digital token management in accordance with examples as disclosed herein. The permissions payload component 625 may be configured as or otherwise support a means for receiving, from a blockchain wallet application, a permissions payload comprising one or more parameters defining usage of a temporary key pair by a client application, wherein the temporary key pair is associated with transferring crypto tokens between a first blockchain address associated with the blockchain wallet application and one or more second blockchain addresses in accordance with the permissions payload, and wherein the permissions payload is signed using a private key associated with the first blockchain address. The transfer request component 630 may be configured as or otherwise support a means for receiving, from the client application, a request to transfer an amount of the crypto tokens between the first blockchain address of the blockchain wallet application and the one or more second blockchain addresses via a blockchain network, wherein the request to transfer comprises a signature using a private key of the temporary key pair. The validating component 635 may be configured as or otherwise support a means for validating the request to transfer based on the signed permissions payload. The message broadcasting component 640 may be configured as or otherwise support a means for broadcasting one or more messages configured to cause transfer of the amount of the crypto tokens via the blockchain network.

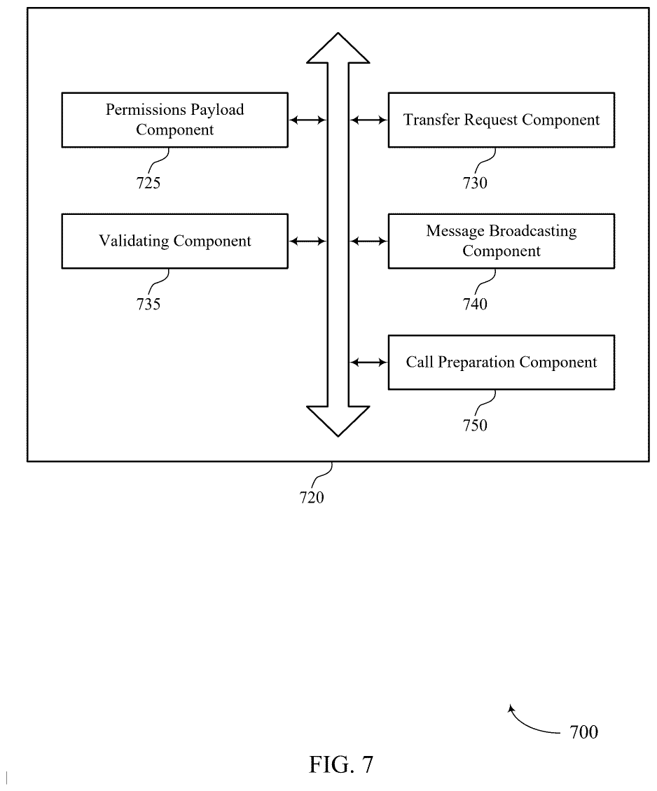

FIG. 7 shows a block diagram 700 of a token management interface 720 that supports generating session keys for smart wallets in accordance with aspects of the present disclosure. The token management interface 720 may be an example of aspects of a token management interface or a token management interface 620, or both, as described herein. The token management interface 720, or various components thereof, may be an example of means for performing various aspects of generating session keys for smart wallets as described herein. For example, the token management interface 720 may include a permissions payload component 725, a transfer request component 730, a validating component 735, a message broadcasting component 740, a call preparation component 750, or any combination thereof. Each of these components, or components of subcomponents thereof (e.g., one or more processors, one or more memories), may communicate, directly or indirectly, with one another (e.g., via one or more buses).

The token management interface 720 may support digital token management in accordance with examples as disclosed herein. The permissions payload component 725 may be configured as or otherwise support a means for receiving, from a blockchain wallet application, a permissions payload comprising one or more parameters defining usage of a temporary key pair by a client application, wherein the temporary key pair is associated with transferring crypto tokens between a first blockchain address associated with the blockchain wallet application and one or more second blockchain addresses in accordance with the permissions payload, and wherein the permissions payload is signed using a private key associated with the first blockchain address. The transfer request component 730 may be configured as or otherwise support a means for receiving, from the client application, a request to transfer an amount of the crypto tokens between the first blockchain address of the blockchain wallet application and the one or more second blockchain addresses via a blockchain network, wherein the request to transfer comprises a signature using a private key of the temporary key pair. The validating component 735 may be configured as or otherwise support a means for validating the request to transfer based on the signed permissions payload. The message broadcasting component 740 may be configured as or otherwise support a means for broadcasting one or more messages configured to cause transfer of the amount of the crypto tokens via the blockchain network.

In some examples, to support validating the request to transfer, the validating component 735 may be configured as or otherwise support a means for broadcasting, via the blockchain network, a signed message configured to call one or more permissions contracts on the blockchain network, wherein the signed message comprises an indication of the request to transfer. In some examples, to support validating the request to transfer, the validating component 735 may be configured as or otherwise support a means for receiving, via the blockchain network, an indication that the request to transfer is validated, wherein the one or more messages are broadcast after receiving the indication that the request to transfer is validated.

In some examples, the signed message is configured to call the one or more permissions contracts that are configured to validate that a permission associated with use of the temporary key pair is not revoked, that the permission is approved by the first blockchain address, that the request to transfer is signed using the private key of the temporary key pair, or any combination thereof.

In some examples, the signed message is configured to call the one or more permissions contracts that are configured to validate that the one or more messages call one or more allowed addresses on the blockchain network, includes a call to an allowance contract configured to monitor satisfaction of recurring allowances associated with the permissions payload, or any combination thereof.

In some examples, the call preparation component 750 may be configured as or otherwise support a means for receiving, from the client application, a request to prepare one or more calls associated with the request to transfer the amount of the crypto tokens between the first blockchain address and the one or more second blockchain addresses. In some examples, the call preparation component 750 may be configured as or otherwise support a means for preparing the one or more calls based at least in part on receiving data associated with the first blockchain address. In some examples, the call preparation component 750 may be configured as or otherwise support a means for transmitting, to the client application, the prepared one or more calls and a hash value associated with the prepared one or more calls, wherein the request to transfer comprises the signature over the hash value using the private key.

In some examples, the validating component 735 may be configured as or otherwise support a means for signing, using a key associated with a server supporting the blockchain wallet application, the request to transfer the amount of the crypto tokens between the first blockchain address and the one or more second blockchain addresses based at least in part on the validating.

In some examples, the one or more messages are further configured to call one or more allowance contracts that are configured to determine whether the amount exceeds a threshold amount defined by the one or more parameters of the permissions payload.

In some examples, the one or more parameters comprise a duration for which the temporary key pair is valid, a threshold amount of crypto tokens that are approved for transfer between the first blockchain address and the one or more second blockchain addresses, the one or more second blockchain addresses via which transfer of crypto tokens is approved, a threshold quantity of requests to transfer the crypto tokens between the first blockchain address and the one or more second blockchain addresses that are approved, a type of crypto token that is approved for transfer between the first blockchain address and the one or more second blockchain addresses, or any combination thereof.

FIG. 8 shows a diagram of a system 800 including a device 805 that supports generating session keys for smart wallets in accordance with aspects of the present disclosure. The device 805 may be an example of or include components of a device 605 as described herein. The device 805 may include components for bi-directional voice and data communications including components for transmitting and receiving communications, such as a token management interface 820, an input information 810, an output information 815, a network interface 825, at least one memory 830, at least one processor 835, and a storage 840. Each of these components may communicate, directly or indirectly, with one another (e.g., via one or more buses, communications links, communications interfaces, or any combination thereof).

The network interface 825 may enable the device 805 to exchange information (e.g., input information 810, output information 815, or both) with other systems or devices (not shown). For example, the network interface 825 may enable the device 805 to connect to a network (e.g., a network 135 as described herein). The network interface 825 may include one or more wireless network interfaces, one or more wired network interfaces, or any combination thereof.

Memory 830 may include RAM, ROM, or both. The memory 830 may store computer-readable, computer-executable software including instructions that, when executed, cause at least one processor 835 to perform various functions described herein, such as functions supporting generating session keys for smart wallets. In some cases, the memory 830 may contain, among other things, a basic input/output system (BIOS), which may control basic hardware or software operation such as the interaction with peripheral components or devices. In some cases, the memory 830 may be an example of aspects of one or more components of a custodial token platform 110 as described with reference to FIG. 1. The memory 830 may be an example of a single memory or multiple memories. For example, the device 805 may include one or more memories 830.

The processor 835 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 835 may be configured to execute computer-readable instructions stored in at least one memory 830 to perform various functions (e.g., functions or tasks supporting generating session keys for smart wallets). Though a single processor 835 is depicted in the example of FIG. 8, it is to be understood that the device 805 may include any quantity of one or more of processors 835 and that a group of processors 835 may collectively perform one or more functions ascribed herein to a processor, such as the processor 835. The processor 835 may be an example of a single processor or multiple processors. For example, the device 805 may include one or more processors 835.

Storage 840 may be configured to store data that is generated, processed, stored, or otherwise used by the device 805. In some cases, the storage 840 may include one or more HDDs, one or more SDDs, or both. In some examples, the storage 840 may be an example of a single database, a distributed database, multiple distributed databases, a data store, a data lake, or an emergency backup database. In some examples, the storage 840 may be an example of one or more components described with reference to FIG. 1.

The token management interface 820 may support digital token management in accordance with examples as disclosed herein. For example, the token management interface 820 may be configured as or otherwise support a means for receiving, from a blockchain wallet application, a permissions payload comprising one or more parameters defining usage of a temporary key pair by a client application, wherein the temporary key pair is associated with transferring crypto tokens between a first blockchain address associated with the blockchain wallet application and one or more second blockchain addresses in accordance with the permissions payload, and wherein the permissions payload is signed using a private key associated with the first blockchain address. The token management interface 820 may be configured as or otherwise support a means for receiving, from the client application, a request to transfer an amount of the crypto tokens between the first blockchain address of the blockchain wallet application and the one or more second blockchain addresses via a blockchain network, wherein the request to transfer comprises a signature using a private key of the temporary key pair. The token management interface 820 may be configured as or otherwise support a means for validating the request to transfer based on the signed permissions payload. The token management interface 820 may be configured as or otherwise support a means for broadcasting one or more messages configured to cause transfer of the amount of the crypto tokens via the blockchain network.

Additionally, or alternatively, the token management interface 820 may support digital token management in accordance with examples as disclosed herein. For example, the token management interface 820 may be configured as or otherwise support a means for one or more memories storing processor-executable code. The token management interface 820 may be configured as or otherwise support a means for one or more processors coupling with the one or more memories and individually or collectively operable to execute the code to cause the apparatus to. The token management interface 820 may be configured as or otherwise support a means for receiving, from a blockchain wallet application, a permissions payload comprising one or more parameters defining usage of a temporary key pair by a client application, wherein the temporary key pair is associated with transferring crypto tokens between a first blockchain address associated with the blockchain wallet application and one or more second blockchain addresses in accordance with the permissions payload, and wherein the permissions payload is signed using a private key associated with the first blockchain address. The token management interface 820 may be configured as or otherwise support a means for receiving, from the client application, a request to transfer an amount of the crypto tokens between the first blockchain address of the blockchain wallet application and the one or more second blockchain addresses via a blockchain network, wherein the request to transfer comprises a signature using a private key of the temporary key pair. The token management interface 820 may be configured as or otherwise support a means for broadcasting, via the blockchain network, a signed message configured to call one or more permissions contracts on the blockchain network, wherein the one or more permissions contracts are configured to validate the signed message using the permissions payload. The token management interface 820 may be configured as or otherwise support a means for broadcasting, after broadcasting the signed message, one or more messages configured to cause transfer of the amount of the crypto tokens via the blockchain network.

Additionally, or alternatively, the token management interface 820 may support digital token management in accordance with examples as disclosed herein. For example, the token management interface 820 may be configured as or otherwise support a means for receiving, from a blockchain wallet application, a permissions payload comprising one or more parameters defining usage of a temporary key pair by a client application, wherein the temporary key pair is associated with transferring crypto tokens between a first blockchain address associated with the blockchain wallet application and one or more second blockchain addresses in accordance with the permissions payload, and wherein the permissions payload is signed using a private key associated with the first blockchain address. The token management interface 820 may be configured as or otherwise support a means for receiving, from the client application, a request to transfer an amount of the crypto tokens between the first blockchain address of the blockchain wallet application and the one or more second blockchain addresses via a blockchain network, wherein the request to transfer comprises a signature using a private key of the temporary key pair. The token management interface 820 may be configured as or otherwise support a means for validating the request to transfer based on the signed permissions payload. The token management interface 820 may be configured as or otherwise support a means for broadcasting one or more messages configured to. The token management interface 820 may be configured as or otherwise support a means for calling one or more allowance contracts that are configured to determine whether the amount exceeds a threshold amount defined by the one or more parameters of the permissions payload. The token management interface 820 may be configured as or otherwise support a means for causing transfer of the amount of the crypto tokens via the blockchain network.

By including or configuring the token management interface 820 in accordance with examples as described herein, the device 805 may support techniques for generating temporary key pairs, which may improve user experience associated with performing transactions using crypto token in a client application.

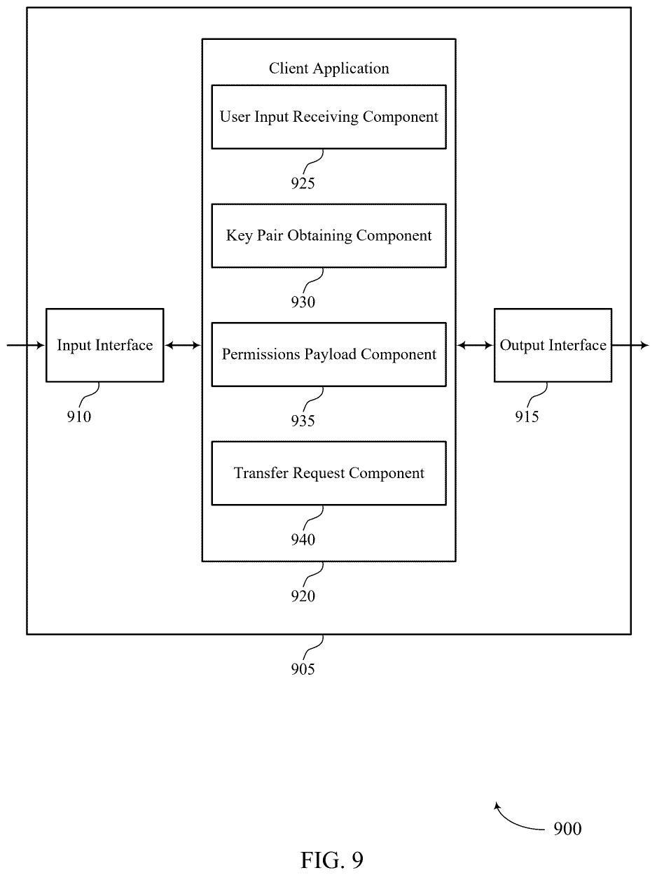

FIG. 9 shows a block diagram 900 of a device 905 that supports generating session keys for smart wallets in accordance with aspects of the present disclosure. The device 905 may include an input interface 910, an output interface 915, and a client application 920. The device 905, or one or more components of the device 905 (e.g., the input interface 910, the output interface 915, the client application 920), may include at least one processor, which may be coupled with at least one memory, to support the described techniques. Each of these components may be in communication with one another (e.g., via one or more buses).

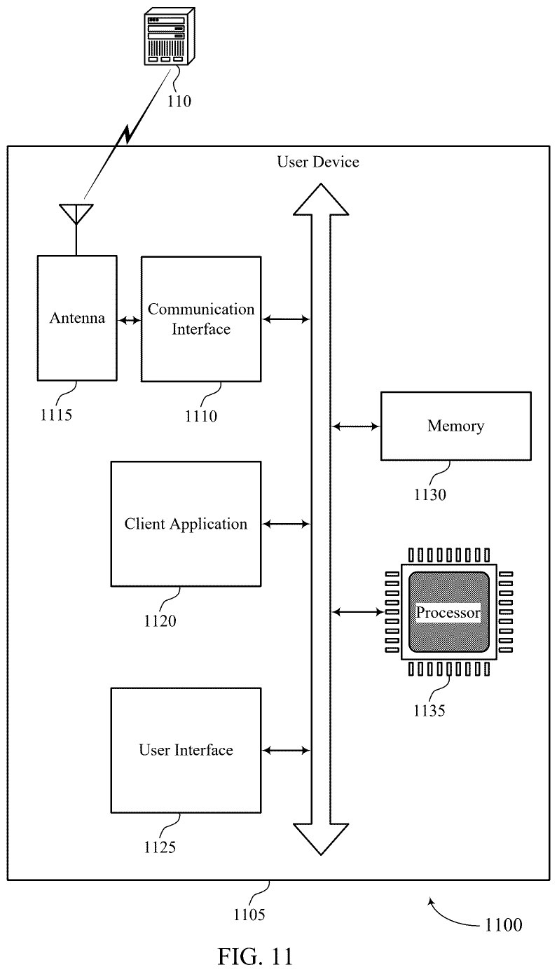

The input interface 910 may manage input signaling for the user device 905. For example, the input interface 910 may receive input signaling (e.g., messages, packets, data, instructions, commands, transactions, or any other form of encoded information) from other systems or devices. The input interface 910 may send signaling corresponding to (e.g., representative of or otherwise based on) such input signaling to other components of the user device 905 for processing. For example, the input interface 910 may transmit such corresponding signaling to the client application 920 to support generating session keys for smart wallets. In some cases, the input interface 910 may be a component of a communication interface 1110 as described with reference to FIG. 11.

The output interface 915 may manage output signaling for the user device 905. For example, the output interface 915 may receive signaling from other components of the user device 905, such as the client application 920, and may transmit such output signaling corresponding to (e.g., representative of or otherwise based on) such signaling to other systems or devices. In some cases, the output interface 915 may be a component of a user interface 1125 as described with reference to FIG. 11.

For example, the client application 920 may include a user input receiving component 925, a key pair obtaining component 930, a permissions payload component 935, a transfer request component 940, or any combination thereof. In some examples, the client application 920, or various components thereof, may be configured to perform various operations (e.g., receiving, monitoring, transmitting) using or otherwise in cooperation with the input interface 910, the output interface 915, or both. For example, the client application 920 may receive information from the input interface 910, send information to the output interface 915, or be integrated in combination with the input interface 910, the output interface 915, or both to receive information, transmit information, or perform various other operations as described herein.

The client application 920 may support digital token management in accordance with examples as disclosed herein. The user input receiving component 925 may be configured as or otherwise support a means for receiving, at a client application, user input to provide permissions to the client application associated with transferring crypto tokens between a first blockchain address associated with a blockchain wallet application and one or more second blockchain addresses. The key pair obtaining component 930 may be configured as or otherwise support a means for obtaining, after receiving the user input, a temporary key pair that is associated with transferring tokens between the first blockchain address associated with the blockchain wallet application and the one or more second blockchain addresses. The permissions payload component 935 may be configured as or otherwise support a means for transmitting, to the blockchain wallet application, a permissions payload comprising one or more parameters defining usage of the temporary key pair by the client application and an indication a public key of the temporary key pair. The permissions payload component 935 may be configured as or otherwise support a means for receiving the permissions payload that is signed using a private key associated with the first blockchain address. The transfer request component 940 may be configured as or otherwise support a means for transmitting, to one or more servers associated with the blockchain wallet application, a request to transfer an amount of the crypto tokens between the first blockchain address and the one or more second blockchain addresses via a blockchain network, wherein the request to transfer is signed using a private key of the temporary key pair.

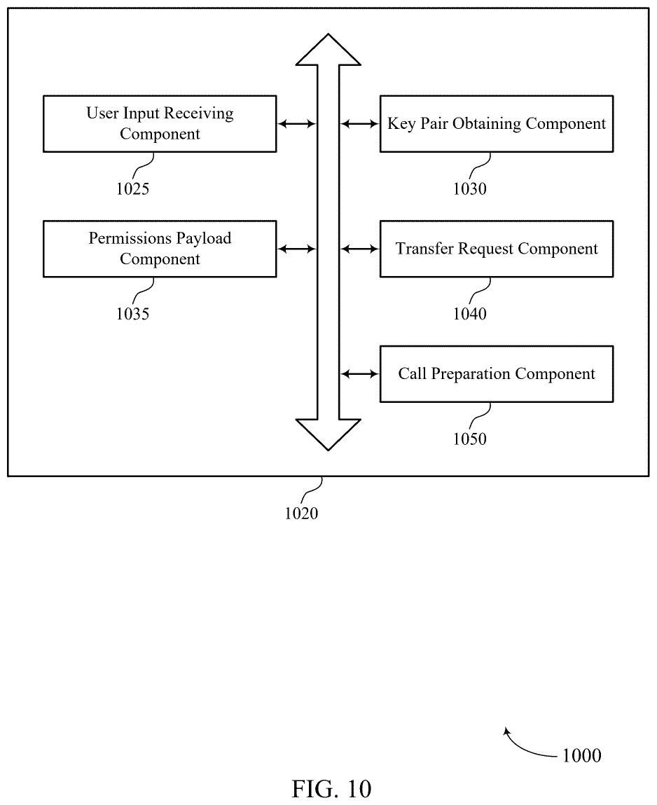

FIG. 10 shows a block diagram 1000 of a client application 1020 that supports generating session keys for smart wallets in accordance with aspects of the present disclosure. The client application 1020 may be an example of aspects of a client application or a client application 920, or both, as described herein. The client application 1020, or various components thereof, may be an example of means for performing various aspects of generating session keys for smart wallets as described herein. For example, the client application 1020 may include a user input receiving component 1025, a key pair obtaining component 1030, a permissions payload component 1035, a transfer request component 1040, a call preparation component 1050, or any combination thereof. Each of these components, or components of subcomponents thereof (e.g., one or more processors, one or more memories), may communicate, directly or indirectly, with one another (e.g., via one or more buses).

The client application 1020 may support digital token management in accordance with examples as disclosed herein. The user input receiving component 1025 may be configured as or otherwise support a means for receiving, at a client application, user input to provide permissions to the client application associated with transferring crypto tokens between a first blockchain address associated with a blockchain wallet application and one or more second blockchain addresses. The key pair obtaining component 1030 may be configured as or otherwise support a means for obtaining, after receiving the user input, a temporary key pair that is associated with transferring tokens between the first blockchain address associated with the blockchain wallet application and the one or more second blockchain addresses. The permissions payload component 1035 may be configured as or otherwise support a means for transmitting, to the blockchain wallet application, a permissions payload comprising one or more parameters defining usage of the temporary key pair by the client application and an indication a public key of the temporary key pair. In some examples, the permissions payload component 1035 may be configured as or otherwise support a means for receiving the permissions payload that is signed using a private key associated with the first blockchain address. The transfer request component 1040 may be configured as or otherwise support a means for transmitting, to one or more servers associated with the blockchain wallet application, a request to transfer an amount of the crypto tokens between the first blockchain address and the one or more second blockchain addresses via a blockchain network, wherein the request to transfer is signed using a private key of the temporary key pair.

In some examples, to support obtaining the temporary key pair, the key pair obtaining component 1030 may be configured as or otherwise support a means for generating the temporary key pair via a key service of the client application.

In some examples, to support obtaining the temporary key pair, the key pair obtaining component 1030 may be configured as or otherwise support a means for transmitting, to a software development kit associated with the blockchain wallet application and installed by the client application, a request to generate the temporary key pair, wherein the software development kit generates and stores the temporary key pair.

In some examples, to support receiving the permissions payload, the permissions payload component 1035 may be configured as or otherwise support a means for receiving, from a software development kit associated with the blockchain wallet application and installed by the client application, the permissions payload.

In some examples, to support transmitting the request to transfer, the transfer request component 1040 may be configured as or otherwise support a means for transmitting, to a software development kit associated with the blockchain wallet application and installed by the client application, the request to transfer, wherein the software development kit is configured to transfer the request to transfer to the one or more servers.

In some examples, the call preparation component 1050 may be configured as or otherwise support a means for transmitting, to the one or more servers, a request to prepare one or more calls associated with the request to transfer the amount of the crypto tokens between the first blockchain address and the one or more second blockchain addresses. In some examples, the call preparation component 1050 may be configured as or otherwise support a means for receiving, from the one or more servers after transmitting the request to prepare the one or more calls, the prepared one or more calls and a hash value associated with the prepared calls, wherein the request to transfer is signed based on a signature over the hash value using the private key of the temporary key pair.

In some examples, the one or more parameters comprise a duration for which the temporary key pair is valid, a threshold amount of crypto tokens that are approved for transfer between the first blockchain address and the one or more second blockchain addresses, the one or more second blockchain addresses via which transfer of crypto tokens is approved, a threshold quantity of requests to transfer the crypto tokens between the first blockchain address and the one or more second blockchain addresses that are approved, a type of crypto token that is approved for transfer between the first blockchain address and the one or more second blockchain addresses, or any combination thereof.

FIG. 11 shows a diagram of a system 1100 including a device 1105 that supports generating session keys for smart wallets in accordance with aspects of the present disclosure. The device 1105 may be an example of or include components of a device 905 as described herein. The device 1105 may include components for bi-directional voice and data communications including components for transmitting and receiving communications, such as a client application 1120, a communication interface 1110, one or more antennas 1115, a user interface 1125, at least one memory 1130, and at least one processor 1135. Each of these components may communicate, directly or indirectly, with one another (e.g., via one or more buses, communications links, communications interfaces, or any combination thereof).

The communication interface 1110 may manage input and output signals for the device 1105 via the antenna 1115. For example, the communication interface 1110 may enable the user device 1105 to exchange information (e.g., input information, output information, or both) with other systems or devices, such as custodial token platform 110 (e.g., supported by one or more servers), via one or more wired or wireless communication links. The communication interface 1110 may also utilize or interact with antenna 1115 to support communication with other systems or devices. In some cases, the communication interface 1110 may represent a physical connection or port to an external peripheral, such as a hardware wallet device. In some cases, the communication interface 1110 may utilize an operating system such as iOS®, ANDROID®, MS-DOS®, MS-WINDOWS®, OS/2®, UNIX®, LINUX®, or another known operating system. The communication interface 1110 may be implemented as part of the processor 1135.

In some cases, the device 1105 may include a single antenna 1115. However, in some other cases, the device 1105 may have more than one antenna 1115, which may be capable of concurrently transmitting or receiving multiple wireless transmissions. The communication interface 1110 may communicate bi-directionally, via the one or more antennas 1115, wired, or wireless links as described herein. For example, the communication interface 1110 may represent a wireless transceiver and may communicate bi-directionally with another wireless transceiver. The communication interface 1110 may also include a modem to modulate the packets, to provide the modulated packets to one or more antennas 1115 for transmission, and to demodulate packets received from the one or more antennas 1115.

The user interface 1125 may represent a keyboard, a mouse, a touchscreen, a microphone, or a similar device or component. In some cases, a user may interact with the user interface 1125. In other cases, the user interface 1125 may operate automatically without user interaction. The user interface 1125 may display or output information such as information received from other systems or devices or information to be transmitted to other systems or devices.

The memory 1130 may include RAM and ROM. The memory 1130 may store computer-readable, computer-executable software including instructions that, when executed, cause at least one processor 1135 to perform various functions described herein. In some cases, the memory 1130 may contain, among other things, a BIOS which may control basic hardware or software operation such as the interaction with peripheral components or devices. The memory 1130 may be an example of a single memory or multiple memories. For example, the user device 1105 may include one or more memories 1130.

The processor 1135 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1135 may be configured to operate a memory array using a memory controller. In other cases, a memory controller may be integrated into the processor 1135. The processor 1135 may be configured to execute computer-readable instructions stored in at least one memory 1130 to perform various functions (e.g., functions or tasks supporting a method and system for generating session keys for smart wallets). Though a single processor 1135 is depicted in the example of FIG. 11, it is to be understood that the user device 1105 may include any quantity of one or more of processors 1135 and that a group of processors 1135 may collectively perform one or more functions ascribed herein to a processor, such as the processor 1135. The processor 1135 may be an example of a single processor or multiple processors. For example, the device 1105 may include one or more processors 1135.

The client application 1120 may support digital token management in accordance with examples as disclosed herein. For example, the client application 1120 may be configured as or otherwise support a means for receiving, at a client application, user input to provide permissions to the client application associated with transferring crypto tokens between a first blockchain address associated with a blockchain wallet application and one or more second blockchain addresses. The client application 1120 may be configured as or otherwise support a means for obtaining, after receiving the user input, a temporary key pair that is associated with transferring tokens between the first blockchain address associated with the blockchain wallet application and the one or more second blockchain addresses. The client application 1120 may be configured as or otherwise support a means for transmitting, to the blockchain wallet application, a permissions payload comprising one or more parameters defining usage of the temporary key pair by the client application and an indication a public key of the temporary key pair. The client application 1120 may be configured as or otherwise support a means for receiving the permissions payload that is signed using a private key associated with the first blockchain address. The client application 1120 may be configured as or otherwise support a means for transmitting, to one or more servers associated with the blockchain wallet application, a request to transfer an amount of the crypto tokens between the first blockchain address and the one or more second blockchain addresses via a blockchain network, wherein the request to transfer is signed using a private key of the temporary key pair.

Additionally, or alternatively, the client application 1120 may support digital token management in accordance with examples as disclosed herein. For example, the client application 1120 may be configured as or otherwise support a means for one or more memories storing processor-executable code. The client application 1120 may be configured as or otherwise support a means for one or more processors coupling with the one or more memories and individually or collectively operable to execute the code to cause the apparatus to. The client application 1120 may be configured as or otherwise support a means for receiving, at a client application, a user input to provide permissions to the client application associated with transferring crypto tokens between a first blockchain address associated with a blockchain wallet application and one or more second blockchain addresses. The client application 1120 may be configured as or otherwise support a means for obtaining, after receiving the user input, a temporary key pair that is associated with transferring tokens between the first blockchain address associated with the blockchain wallet application and the one or more second blockchain addresses. The client application 1120 may be configured as or otherwise support a means for transmitting, to the blockchain wallet application, a permissions payload comprising one or more parameters defining usage of the temporary key pair by the client application and an indication a public key of the temporary key pair. The client application 1120 may be configured as or otherwise support a means for receiving the permissions payload that is signed using a private key associated with the first blockchain address. The client application 1120 may be configured as or otherwise support a means for transmitting a request to transfer an amount of the crypto tokens between the first blockchain address and the one or more second blockchain addresses via a blockchain network, wherein the request to transfer is signed using a private key of the temporary key pair.

Additionally, or alternatively, the client application 1120 may support digital token management in accordance with examples as disclosed herein. For example, the client application 1120 may be configured as or otherwise support a means for receiving, at a client application, a user input to provide permissions to the client application associated with transferring crypto tokens between a first blockchain address associated with a blockchain wallet application and one or more second blockchain addresses. The client application 1120 may be configured as or otherwise support a means for generating, at the client application after receiving the user input, a temporary key pair that is associated with transferring tokens between the first blockchain address associated with the blockchain wallet application and the one or more second blockchain addresses. The client application 1120 may be configured as or otherwise support a means for transmitting, to the blockchain wallet application, a permissions payload comprising one or more parameters defining usage of the temporary key pair by the client application and an indication a public key of the temporary key pair. The client application 1120 may be configured as or otherwise support a means for receiving the permissions payload that is signed using a private key associated with the first blockchain address. The client application 1120 may be configured as or otherwise support a means for transmitting, to one or more servers associated with the blockchain wallet application, a request to transfer an amount of the crypto tokens between the first blockchain address and the one or more second blockchain addresses via a blockchain network, wherein the request to transfer is signed using a private key of the temporary key pair.

By including or configuring the client application 1120 in accordance with examples as described herein, the device 1105 may support techniques for generating temporary key pairs, which may improve user experience associated with performing transactions using crypto token in a client application.

The client application 1120 may include an application (e.g., “app”), program, software, extension, or other component which is configured to facilitate communications with a custodial token platform 110 on a server, one or more nodes of a blockchain network 105, other user devices 1105, and other devices or systems. For example, the client application 1120 may be an application executable on the user device 1105, and the client application 1120 may be configured to receive data from a custodial token platform 110, transmit data to the custodial token platform 110, process such data, and cause presentation of such data to a user via a user interface 1125. The client application 1120 may be an example of a wallet application, a wallet device, or both, and may be associated with a wallet address and may access or use a private key to sign messages to facilitate transfer of crypto tokens, messages, transactions, or the like via a blockchain distributed data store.

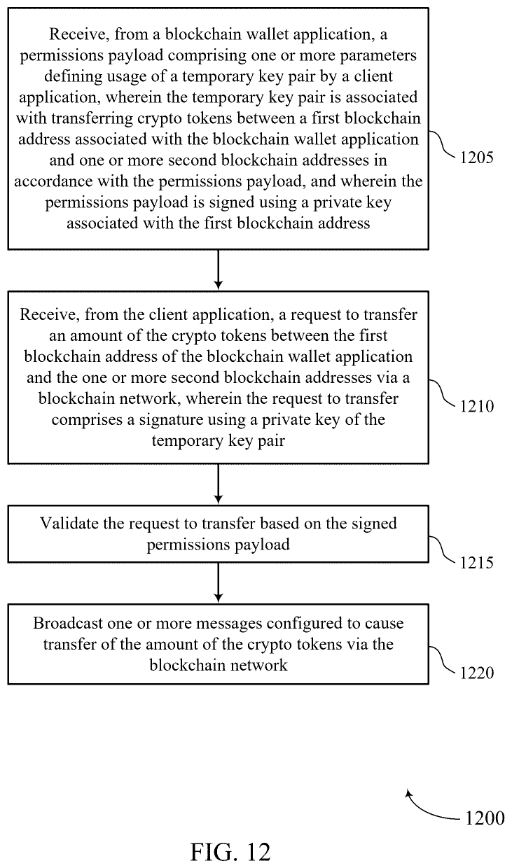

FIG. 12 shows a flowchart illustrating a method 1200 that supports generating session keys for smart wallets in accordance with aspects of the present disclosure. The operations of the method 1200 may be implemented by a custodial token platform or its components as described herein. For example, the operations of the method 1200 may be performed by a custodial token platform as described with reference to FIGS. 1 through 8. In some examples, a custodial token platform may execute a set of instructions to control the functional elements of the custodial token platform to perform the described functions. Additionally, or alternatively, the custodial token platform may perform aspects of the described functions using special-purpose hardware.

At 1205, the method may include receiving, from a blockchain wallet application, a permissions payload comprising one or more parameters defining usage of a temporary key pair by a client application, wherein the temporary key pair is associated with transferring crypto tokens between a first blockchain address associated with the blockchain wallet application and one or more second blockchain addresses in accordance with the permissions payload, and wherein the permissions payload is signed using a private key associated with the first blockchain address. The operations of 1205 may be performed in accordance with examples as disclosed herein. In some examples, aspects of the operations of 1205 may be performed by a permissions payload component 725 as described with reference to FIG. 7.

At 1210, the method may include receiving, from the client application, a request to transfer an amount of the crypto tokens between the first blockchain address of the blockchain wallet application and the one or more second blockchain addresses via a blockchain network, wherein the request to transfer comprises a signature using a private key of the temporary key pair. The operations of 1210 may be performed in accordance with examples as disclosed herein. In some examples, aspects of the operations of 1210 may be performed by a transfer request component 730 as described with reference to FIG. 7.

At 1215, the method may include validating the request to transfer based on the signed permissions payload. The operations of 1215 may be performed in accordance with examples as disclosed herein. In some examples, aspects of the operations of 1215 may be performed by a validating component 735 as described with reference to FIG. 7.

At 1220, the method may include broadcasting one or more messages configured to cause transfer of the amount of the crypto tokens via the blockchain network. The operations of 1220 may be performed in accordance with examples as disclosed herein. In some examples, aspects of the operations of 1220 may be performed by a message broadcasting component 740 as described with reference to FIG. 7.

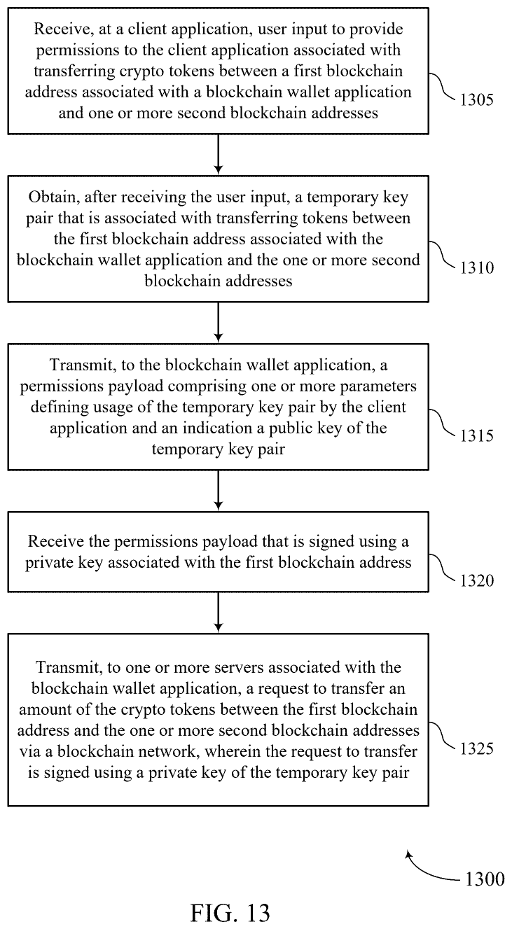

FIG. 13 shows a flowchart illustrating a method 1300 that supports generating session keys for smart wallets in accordance with aspects of the present disclosure. The operations of the method 1300 may be implemented by a user device or its components as described herein. For example, the operations of the method 1300 may be performed by a user device as described with reference to FIGS. 1 through 3 and 9 through 11. In some examples, a user device may execute a set of instructions to control the functional elements of the user device to perform the described functions. Additionally, or alternatively, the user device may perform aspects of the described functions using special-purpose hardware.

At 1305, the method may include receiving, at a client application, user input to provide permissions to the client application associated with transferring crypto tokens between a first blockchain address associated with a blockchain wallet application and one or more second blockchain addresses. The operations of 1305 may be performed in accordance with examples as disclosed herein. In some examples, aspects of the operations of 1305 may be performed by a user input receiving component 1025 as described with reference to FIG. 10.

At 1310, the method may include obtaining, after receiving the user input, a temporary key pair that is associated with transferring tokens between the first blockchain address associated with the blockchain wallet application and the one or more second blockchain addresses. The operations of 1310 may be performed in accordance with examples as disclosed herein. In some examples, aspects of the operations of 1310 may be performed by a key pair obtaining component 1030 as described with reference to FIG. 10.

At 1315, the method may include transmitting, to the blockchain wallet application, a permissions payload comprising one or more parameters defining usage of the temporary key pair by the client application and an indication a public key of the temporary key pair. The operations of 1315 may be performed in accordance with examples as disclosed herein. In some examples, aspects of the operations of 1315 may be performed by a permissions payload component 1035 as described with reference to FIG. 10.

At 1320, the method may include receiving the permissions payload that is signed using a private key associated with the first blockchain address. The operations of 1320 may be performed in accordance with examples as disclosed herein. In some examples, aspects of the operations of 1320 may be performed by a permissions payload component 1035 as described with reference to FIG. 10.

At 1325, the method may include transmitting, to one or more servers associated with the blockchain wallet application, a request to transfer an amount of the crypto tokens between the first blockchain address and the one or more second blockchain addresses via a blockchain network, wherein the request to transfer is signed using a private key of the temporary key pair. The operations of 1325 may be performed in accordance with examples as disclosed herein. In some examples, aspects of the operations of 1325 may be performed by a transfer request component 1040 as described with reference to FIG. 10.

A method for digital token management by an apparatus is described. The method may include receiving, from a blockchain wallet application, a permissions payload comprising one or more parameters defining usage of a temporary key pair by a client application, wherein the temporary key pair is associated with transferring crypto tokens between a first blockchain address associated with the blockchain wallet application and one or more second blockchain addresses in accordance with the permissions payload, and wherein the permissions payload is signed using a private key associated with the first blockchain address, receiving, from the client application, a request to transfer an amount of the crypto tokens between the first blockchain address of the blockchain wallet application and the one or more second blockchain addresses via a blockchain network, wherein the request to transfer comprises a signature using a private key of the temporary key pair, validating the request to transfer based on the signed permissions payload, and broadcasting one or more messages configured to cause transfer of the amount of the crypto tokens via the blockchain network.

An apparatus for digital token management is described. The apparatus may include one or more memories storing processor executable code, and one or more processors coupled with the one or more memories. The one or more processors may individually or collectively be operable to execute the code to cause the apparatus to receive, from a blockchain wallet application, a permissions payload comprising one or more parameters defining usage of a temporary key pair by a client application, wherein the temporary key pair is associated with transferring crypto tokens between a first blockchain address associated with the blockchain wallet application and one or more second blockchain addresses in accordance with the permissions payload, and wherein the permissions payload is signed using a private key associated with the first blockchain address, receive, from the client application, a request to transfer an amount of the crypto tokens between the first blockchain address of the blockchain wallet application and the one or more second blockchain addresses via a blockchain network, wherein the request to transfer comprises a signature using a private key of the temporary key pair, validate the request to transfer based on the signed permissions payload, and broadcast one or more messages configured to cause transfer of the amount of the crypto tokens via the blockchain network.

Another apparatus for digital token management is described. The apparatus may include means for receiving, from a blockchain wallet application, a permissions payload comprising one or more parameters defining usage of a temporary key pair by a client application, wherein the temporary key pair is associated with transferring crypto tokens between a first blockchain address associated with the blockchain wallet application and one or more second blockchain addresses in accordance with the permissions payload, and wherein the permissions payload is signed using a private key associated with the first blockchain address, means for receiving, from the client application, a request to transfer an amount of the crypto tokens between the first blockchain address of the blockchain wallet application and the one or more second blockchain addresses via a blockchain network, wherein the request to transfer comprises a signature using a private key of the temporary key pair, means for validating the request to transfer based on the signed permissions payload, and means for broadcasting one or more messages configured to cause transfer of the amount of the crypto tokens via the blockchain network.

A non-transitory computer-readable medium storing code for digital token management is described. The code may include instructions executable by one or more processors to receive, from a blockchain wallet application, a permissions payload comprising one or more parameters defining usage of a temporary key pair by a client application, wherein the temporary key pair is associated with transferring crypto tokens between a first blockchain address associated with the blockchain wallet application and one or more second blockchain addresses in accordance with the permissions payload, and wherein the permissions payload is signed using a private key associated with the first blockchain address, receive, from the client application, a request to transfer an amount of the crypto tokens between the first blockchain address of the blockchain wallet application and the one or more second blockchain addresses via a blockchain network, wherein the request to transfer comprises a signature using a private key of the temporary key pair, validate the request to transfer based on the signed permissions payload, and broadcast one or more messages configured to cause transfer of the amount of the crypto tokens via the blockchain network.

In some examples of the method, apparatus, and non-transitory computer-readable medium described herein, validating the request to transfer may include operations, features, means, or instructions for broadcasting, via the blockchain network, a signed message configured to call one or more permissions contracts on the blockchain network, wherein the signed message comprises an indication of the request to transfer and receiving, via the blockchain network, an indication that the request to transfer may be validated, wherein the one or more messages may be broadcast after receiving the indication that the request to transfer may be validated.

In some examples of the method, apparatus, and non-transitory computer-readable medium described herein, the signed message may be configured to call the one or more permissions contracts that may be configured to validate that a permission associated with use of the temporary key pair may be not revoked, that the permission may be approved by the first blockchain address, that the request to transfer may be signed using the private key of the temporary key pair, or any combination thereof.

In some examples of the method, apparatus, and non-transitory computer-readable medium described herein, the signed message may be configured to call the one or more permissions contracts that may be configured to validate that the one or more messages call one or more allowed addresses on the blockchain network, includes a call to an allowance contract configured to monitor satisfaction of recurring allowances associated with the permissions payload, or any combination thereof.

Some examples of the method, apparatus, and non-transitory computer-readable medium described herein may further include operations, features, means, or instructions for receiving, from the client application, a request to prepare one or more calls associated with the request to transfer the amount of the crypto tokens between the first blockchain address and the one or more second blockchain addresses, preparing the one or more calls based at least in part on receiving data associated with the first blockchain address, and transmitting, to the client application, the prepared one or more calls and a hash value associated with the prepared one or more calls, wherein the request to transfer comprises the signature over the hash value using the private key.

In some examples of the method, apparatus, and non-transitory computer-readable medium described herein, signing, using a key associated with a server supporting the blockchain wallet application, the request to transfer the amount of the crypto tokens between the first blockchain address and the one or more second blockchain addresses based at least in part on the validating.

In some examples of the method, apparatus, and non-transitory computer-readable medium described herein, the one or more messages may be further configured to call one or more allowance contracts that may be configured to determine whether the amount exceeds a threshold amount defined by the one or more parameters of the permissions payload.

In some examples of the method, apparatus, and non-transitory computer-readable medium described herein, the one or more parameters comprise a duration for which the temporary key pair may be valid, a threshold amount of crypto tokens that may be approved for transfer between the first blockchain address and the one or more second blockchain addresses, the one or more second blockchain addresses via which transfer of crypto tokens may be approved, a threshold quantity of requests to transfer the crypto tokens between the first blockchain address and the one or more second blockchain addresses that may be approved, a type of crypto token that may be approved for transfer between the first blockchain address and the one or more second blockchain addresses, or any combination thereof.

A method for digital token management by an apparatus for digital token management is described. The method may include one or more memories storing processor-executable code, one or more processors coupling with the one or more memories and individually or collectively operable to execute the code to cause the apparatus to, receiving, from a blockchain wallet application, a permissions payload comprising one or more parameters defining usage of a temporary key pair by a client application, wherein the temporary key pair is associated with transferring crypto tokens between a first blockchain address associated with the blockchain wallet application and one or more second blockchain addresses in accordance with the permissions payload, and wherein the permissions payload is signed using a private key associated with the first blockchain address, receiving, from the client application, a request to transfer an amount of the crypto tokens between the first blockchain address of the blockchain wallet application and the one or more second blockchain addresses via a blockchain network, wherein the request to transfer comprises a signature using a private key of the temporary key pair, broadcasting, via the blockchain network, a signed message configured to call one or more permissions contracts on the blockchain network, wherein the one or more permissions contracts are configured to validate the signed message using the permissions payload, and broadcasting, after broadcasting the signed message, one or more messages configured to cause transfer of the amount of the crypto tokens via the blockchain network.

An apparatus for digital token management for digital token management is described. The apparatus for digital token management may include one or more memories storing processor executable code, and one or more processors coupled with the one or more memories. The one or more processors may individually or collectively be operable to execute the code to cause the apparatus for digital token management to one or more memories storing processor-executable code, one or more processors coupled with the one or more memories and individually or collectively operable to execute the code to cause the apparatus to, receive, from a blockchain wallet application, a permissions payload comprising one or more parameters defining usage of a temporary key pair by a client application, wherein the temporary key pair is associated with transferring crypto tokens between a first blockchain address associated with the blockchain wallet application and one or more second blockchain addresses in accordance with the permissions payload, and wherein the permissions payload is signed using a private key associated with the first blockchain address, receive, from the client application, a request to transfer an amount of the crypto tokens between the first blockchain address of the blockchain wallet application and the one or more second blockchain addresses via a blockchain network, wherein the request to transfer comprises a signature using a private key of the temporary key pair, broadcasting, via the blockchain network, a signed message configured to call one or more permissions contracts on the blockchain network, wherein the one or more permissions contracts are configured to validate the signed message using the permissions payload, and broadcast, after broadcasting the signed message, one or more messages configured to cause transfer of the amount of the crypto tokens via the blockchain network.

Another apparatus for digital token management for digital token management is described. The apparatus for digital token management may include means for one or more memories storing processor-executable code, means for one or more processors coupling with the one or more memories and individually or collectively operable to execute the code to cause the apparatus to, means for receiving, from a blockchain wallet application, a permissions payload comprising one or more parameters defining usage of a temporary key pair by a client application, wherein the temporary key pair is associated with transferring crypto tokens between a first blockchain address associated with the blockchain wallet application and one or more second blockchain addresses in accordance with the permissions payload, and wherein the permissions payload is signed using a private key associated with the first blockchain address, means for receiving, from the client application, a request to transfer an amount of the crypto tokens between the first blockchain address of the blockchain wallet application and the one or more second blockchain addresses via a blockchain network, wherein the request to transfer comprises a signature using a private key of the temporary key pair, means for broadcasting, via the blockchain network, a signed message configured to call one or more permissions contracts on the blockchain network, wherein the one or more permissions contracts are configured to validate the signed message using the permissions payload, and means for broadcasting, after broadcasting the signed message, one or more messages configured to cause transfer of the amount of the crypto tokens via the blockchain network.

A non-transitory computer-readable medium storing code for digital token management is described. The code may include instructions executable by one or more processors to one or more memories storing processor-executable code, one or more processors coupled with the one or more memories and individually or collectively operable to execute the code to cause the apparatus to, receive, from a blockchain wallet application, a permissions payload comprising one or more parameters defining usage of a temporary key pair by a client application, wherein the temporary key pair is associated with transferring crypto tokens between a first blockchain address associated with the blockchain wallet application and one or more second blockchain addresses in accordance with the permissions payload, and wherein the permissions payload is signed using a private key associated with the first blockchain address, receive, from the client application, a request to transfer an amount of the crypto tokens between the first blockchain address of the blockchain wallet application and the one or more second blockchain addresses via a blockchain network, wherein the request to transfer comprises a signature using a private key of the temporary key pair, broadcasting, via the blockchain network, a signed message configured to call one or more permissions contracts on the blockchain network, wherein the one or more permissions contracts are configured to validate the signed message using the permissions payload, and broadcast, after broadcasting the signed message, one or more messages configured to cause transfer of the amount of the crypto tokens via the blockchain network.

A method for digital token management by an apparatus is described. The method may include receiving, from a blockchain wallet application, a permissions payload comprising one or more parameters defining usage of a temporary key pair by a client application, wherein the temporary key pair is associated with transferring crypto tokens between a first blockchain address associated with the blockchain wallet application and one or more second blockchain addresses in accordance with the permissions payload, and wherein the permissions payload is signed using a private key associated with the first blockchain address, receiving, from the client application, a request to transfer an amount of the crypto tokens between the first blockchain address of the blockchain wallet application and the one or more second blockchain addresses via a blockchain network, wherein the request to transfer comprises a signature using a private key of the temporary key pair, validating the request to transfer based on the signed permissions payload, broadcasting one or more messages configured to, calling one or more allowance contracts that are configured to determine whether the amount exceeds a threshold amount defined by the one or more parameters of the permissions payload, and causing transfer of the amount of the crypto tokens via the blockchain network.

An apparatus for digital token management is described. The apparatus may include one or more memories storing processor executable code, and one or more processors coupled with the one or more memories. The one or more processors may individually or collectively be operable to execute the code to cause the apparatus to receive, from a blockchain wallet application, a permissions payload comprising one or more parameters defining usage of a temporary key pair by a client application, wherein the temporary key pair is associated with transferring crypto tokens between a first blockchain address associated with the blockchain wallet application and one or more second blockchain addresses in accordance with the permissions payload, and wherein the permissions payload is signed using a private key associated with the first blockchain address, receive, from the client application, a request to transfer an amount of the crypto tokens between the first blockchain address of the blockchain wallet application and the one or more second blockchain addresses via a blockchain network, wherein the request to transfer comprises a signature using a private key of the temporary key pair, validate the request to transfer based on the signed permissions payload, broadcast one or more messages configured to, call one or more allowance contracts that are configured to determine whether the amount exceeds a threshold amount defined by the one or more parameters of the permissions payload, and cause transfer of the amount of the crypto tokens via the blockchain network.

Another apparatus for digital token management is described. The apparatus may include means for receiving, from a blockchain wallet application, a permissions payload comprising one or more parameters defining usage of a temporary key pair by a client application, wherein the temporary key pair is associated with transferring crypto tokens between a first blockchain address associated with the blockchain wallet application and one or more second blockchain addresses in accordance with the permissions payload, and wherein the permissions payload is signed using a private key associated with the first blockchain address, means for receiving, from the client application, a request to transfer an amount of the crypto tokens between the first blockchain address of the blockchain wallet application and the one or more second blockchain addresses via a blockchain network, wherein the request to transfer comprises a signature using a private key of the temporary key pair, means for validating the request to transfer based on the signed permissions payload, means for broadcasting one or more messages configured to, means for calling one or more allowance contracts that are configured to determine whether the amount exceeds a threshold amount defined by the one or more parameters of the permissions payload, and means for causing transfer of the amount of the crypto tokens via the blockchain network.

A non-transitory computer-readable medium storing code for digital token management is described. The code may include instructions executable by one or more processors to receive, from a blockchain wallet application, a permissions payload comprising one or more parameters defining usage of a temporary key pair by a client application, wherein the temporary key pair is associated with transferring crypto tokens between a first blockchain address associated with the blockchain wallet application and one or more second blockchain addresses in accordance with the permissions payload, and wherein the permissions payload is signed using a private key associated with the first blockchain address, receive, from the client application, a request to transfer an amount of the crypto tokens between the first blockchain address of the blockchain wallet application and the one or more second blockchain addresses via a blockchain network, wherein the request to transfer comprises a signature using a private key of the temporary key pair, validate the request to transfer based on the signed permissions payload, broadcast one or more messages configured to, call one or more allowance contracts that are configured to determine whether the amount exceeds a threshold amount defined by the one or more parameters of the permissions payload, and cause transfer of the amount of the crypto tokens via the blockchain network.

A method for digital token management by an apparatus is described. The method may include receiving, at a client application, user input to provide permissions to the client application associated with transferring crypto tokens between a first blockchain address associated with a blockchain wallet application and one or more second blockchain addresses, obtaining, after receiving the user input, a temporary key pair that is associated with transferring tokens between the first blockchain address associated with the blockchain wallet application and the one or more second blockchain addresses, transmitting, to the blockchain wallet application, a permissions payload comprising one or more parameters defining usage of the temporary key pair by the client application and an indication a public key of the temporary key pair, receiving the permissions payload that is signed using a private key associated with the first blockchain address, and transmitting, to one or more servers associated with the blockchain wallet application, a request to transfer an amount of the crypto tokens between the first blockchain address and the one or more second blockchain addresses via a blockchain network, wherein the request to transfer is signed using a private key of the temporary key pair.

An apparatus for digital token management is described. The apparatus may include one or more memories storing processor executable code, and one or more processors coupled with the one or more memories. The one or more processors may individually or collectively be operable to execute the code to cause the apparatus to receive, at a client application, user input to provide permissions to the client application associated with transferring crypto tokens between a first blockchain address associated with a blockchain wallet application and one or more second blockchain addresses, obtain, after receiving the user input, a temporary key pair that is associated with transferring tokens between the first blockchain address associated with the blockchain wallet application and the one or more second blockchain addresses, transmit, to the blockchain wallet application, a permissions payload comprising one or more parameters defining usage of the temporary key pair by the client application and an indication a public key of the temporary key pair, receive the permissions payload that is signed using a private key associated with the first blockchain address, and transmit, to one or more servers associated with the blockchain wallet application, a request to transfer an amount of the crypto tokens between the first blockchain address and the one or more second blockchain addresses via a blockchain network, wherein the request to transfer is signed using a private key of the temporary key pair.

Another apparatus for digital token management is described. The apparatus may include means for receiving, at a client application, user input to provide permissions to the client application associated with transferring crypto tokens between a first blockchain address associated with a blockchain wallet application and one or more second blockchain addresses, means for obtaining, after receiving the user input, a temporary key pair that is associated with transferring tokens between the first blockchain address associated with the blockchain wallet application and the one or more second blockchain addresses, means for transmitting, to the blockchain wallet application, a permissions payload comprising one or more parameters defining usage of the temporary key pair by the client application and an indication a public key of the temporary key pair, means for receiving the permissions payload that is signed using a private key associated with the first blockchain address, and means for transmitting, to one or more servers associated with the blockchain wallet application, a request to transfer an amount of the crypto tokens between the first blockchain address and the one or more second blockchain addresses via a blockchain network, wherein the request to transfer is signed using a private key of the temporary key pair.

A non-transitory computer-readable medium storing code for digital token management is described. The code may include instructions executable by one or more processors to receive, at a client application, user input to provide permissions to the client application associated with transferring crypto tokens between a first blockchain address associated with a blockchain wallet application and one or more second blockchain addresses, obtain, after receiving the user input, a temporary key pair that is associated with transferring tokens between the first blockchain address associated with the blockchain wallet application and the one or more second blockchain addresses, transmit, to the blockchain wallet application, a permissions payload comprising one or more parameters defining usage of the temporary key pair by the client application and an indication a public key of the temporary key pair, receive the permissions payload that is signed using a private key associated with the first blockchain address, and transmit, to one or more servers associated with the blockchain wallet application, a request to transfer an amount of the crypto tokens between the first blockchain address and the one or more second blockchain addresses via a blockchain network, wherein the request to transfer is signed using a private key of the temporary key pair.

In some examples of the method, apparatus, and non-transitory computer-readable medium described herein, obtaining the temporary key pair may include operations, features, means, or instructions for generating the temporary key pair via a key service of the client application.

In some examples of the method, apparatus, and non-transitory computer-readable medium described herein, obtaining the temporary key pair may include operations, features, means, or instructions for transmitting, to a software development kit associated with the blockchain wallet application and installed by the client application, a request to generate the temporary key pair, wherein the software development kit generates and stores the temporary key pair.

In some examples of the method, apparatus, and non-transitory computer-readable medium described herein, receiving the permissions payload may include operations, features, means, or instructions for receiving, from a software development kit associated with the blockchain wallet application and installed by the client application, the permissions payload.

In some examples of the method, apparatus, and non-transitory computer-readable medium described herein, transmitting the request to transfer may include operations, features, means, or instructions for transmitting, to a software development kit associated with the blockchain wallet application and installed by the client application, the request to transfer, wherein the software development kit may be configured to transfer the request to transfer to the one or more servers.

Some examples of the method, apparatus, and non-transitory computer-readable medium described herein may further include operations, features, means, or instructions for transmitting, to the one or more servers, a request to prepare one or more calls associated with the request to transfer the amount of the crypto tokens between the first blockchain address and the one or more second blockchain addresses and receiving, from the one or more servers after transmitting the request to prepare the one or more calls, the prepared one or more calls and a hash value associated with the prepared calls, wherein the request to transfer may be signed based on a signature over the hash value using the private key of the temporary key pair.

In some examples of the method, apparatus, and non-transitory computer-readable medium described herein, the one or more parameters comprise a duration for which the temporary key pair may be valid, a threshold amount of crypto tokens that may be approved for transfer between the first blockchain address and the one or more second blockchain addresses, the one or more second blockchain addresses via which transfer of crypto tokens may be approved, a threshold quantity of requests to transfer the crypto tokens between the first blockchain address and the one or more second blockchain addresses that may be approved, a type of crypto token that may be approved for transfer between the first blockchain address and the one or more second blockchain addresses, or any combination thereof.

A method for digital token management by an apparatus for digital token management is described. The method may include one or more memories storing processor-executable code, one or more processors coupling with the one or more memories and individually or collectively operable to execute the code to cause the apparatus to, receiving, at a client application, a user input to provide permissions to the client application associated with transferring crypto tokens between a first blockchain address associated with a blockchain wallet application and one or more second blockchain addresses, obtaining, after receiving the user input, a temporary key pair that is associated with transferring tokens between the first blockchain address associated with the blockchain wallet application and the one or more second blockchain addresses, transmitting, to the blockchain wallet application, a permissions payload comprising one or more parameters defining usage of the temporary key pair by the client application and an indication a public key of the temporary key pair, receiving the permissions payload that is signed using a private key associated with the first blockchain address, and transmitting a request to transfer an amount of the crypto tokens between the first blockchain address and the one or more second blockchain addresses via a blockchain network, wherein the request to transfer is signed using a private key of the temporary key pair.

An apparatus for digital token management for digital token management is described. The apparatus for digital token management may include one or more memories storing processor executable code, and one or more processors coupled with the one or more memories. The one or more processors may individually or collectively be operable to execute the code to cause the apparatus for digital token management to one or more memories storing processor-executable code, one or more processors coupled with the one or more memories and individually or collectively operable to execute the code to cause the apparatus to, receive, at a client application, a user input to provide permissions to the client application associated with transferring crypto tokens between a first blockchain address associated with a blockchain wallet application and one or more second blockchain addresses, obtain, after receiving the user input, a temporary key pair that is associated with transferring tokens between the first blockchain address associated with the blockchain wallet application and the one or more second blockchain addresses, transmit, to the blockchain wallet application, a permissions payload comprising one or more parameters defining usage of the temporary key pair by the client application and an indication a public key of the temporary key pair, receive the permissions payload that is signed using a private key associated with the first blockchain address, and transmit a request to transfer an amount of the crypto tokens between the first blockchain address and the one or more second blockchain addresses via a blockchain network, wherein the request to transfer is signed using a private key of the temporary key pair.

Another apparatus for digital token management for digital token management is described. The apparatus for digital token management may include means for one or more memories storing processor-executable code, means for one or more processors coupling with the one or more memories and individually or collectively operable to execute the code to cause the apparatus to, means for receiving, at a client application, a user input to provide permissions to the client application associated with transferring crypto tokens between a first blockchain address associated with a blockchain wallet application and one or more second blockchain addresses, means for obtaining, after receiving the user input, a temporary key pair that is associated with transferring tokens between the first blockchain address associated with the blockchain wallet application and the one or more second blockchain addresses, means for transmitting, to the blockchain wallet application, a permissions payload comprising one or more parameters defining usage of the temporary key pair by the client application and an indication a public key of the temporary key pair, means for receiving the permissions payload that is signed using a private key associated with the first blockchain address, and means for transmitting a request to transfer an amount of the crypto tokens between the first blockchain address and the one or more second blockchain addresses via a blockchain network, wherein the request to transfer is signed using a private key of the temporary key pair.

A non-transitory computer-readable medium storing code for digital token management is described. The code may include instructions executable by one or more processors to one or more memories storing processor-executable code, one or more processors coupled with the one or more memories and individually or collectively operable to execute the code to cause the apparatus to, receive, at a client application, a user input to provide permissions to the client application associated with transferring crypto tokens between a first blockchain address associated with a blockchain wallet application and one or more second blockchain addresses, obtain, after receiving the user input, a temporary key pair that is associated with transferring tokens between the first blockchain address associated with the blockchain wallet application and the one or more second blockchain addresses, transmit, to the blockchain wallet application, a permissions payload comprising one or more parameters defining usage of the temporary key pair by the client application and an indication a public key of the temporary key pair, receive the permissions payload that is signed using a private key associated with the first blockchain address, and transmit a request to transfer an amount of the crypto tokens between the first blockchain address and the one or more second blockchain addresses via a blockchain network, wherein the request to transfer is signed using a private key of the temporary key pair.

A method for digital token management by an apparatus is described. The method may include receiving, at a client application, a user input to provide permissions to the client application associated with transferring crypto tokens between a first blockchain address associated with a blockchain wallet application and one or more second blockchain addresses, generating, at the client application after receiving the user input, a temporary key pair that is associated with transferring tokens between the first blockchain address associated with the blockchain wallet application and the one or more second blockchain addresses, transmitting, to the blockchain wallet application, a permissions payload comprising one or more parameters defining usage of the temporary key pair by the client application and an indication a public key of the temporary key pair, receiving the permissions payload that is signed using a private key associated with the first blockchain address, and transmitting, to one or more servers associated with the blockchain wallet application, a request to transfer an amount of the crypto tokens between the first blockchain address and the one or more second blockchain addresses via a blockchain network, wherein the request to transfer is signed using a private key of the temporary key pair.

An apparatus for digital token management is described. The apparatus may include one or more memories storing processor executable code, and one or more processors coupled with the one or more memories. The one or more processors may individually or collectively be operable to execute the code to cause the apparatus to receive, at a client application, a user input to provide permissions to the client application associated with transferring crypto tokens between a first blockchain address associated with a blockchain wallet application and one or more second blockchain addresses, generate, at the client application after receiving the user input, a temporary key pair that is associated with transferring tokens between the first blockchain address associated with the blockchain wallet application and the one or more second blockchain addresses, transmit, to the blockchain wallet application, a permissions payload comprising one or more parameters defining usage of the temporary key pair by the client application and an indication a public key of the temporary key pair, receive the permissions payload that is signed using a private key associated with the first blockchain address, and transmit, to one or more servers associated with the blockchain wallet application, a request to transfer an amount of the crypto tokens between the first blockchain address and the one or more second blockchain addresses via a blockchain network, wherein the request to transfer is signed using a private key of the temporary key pair.

Another apparatus for digital token management is described. The apparatus may include means for receiving, at a client application, a user input to provide permissions to the client application associated with transferring crypto tokens between a first blockchain address associated with a blockchain wallet application and one or more second blockchain addresses, means for generating, at the client application after receiving the user input, a temporary key pair that is associated with transferring tokens between the first blockchain address associated with the blockchain wallet application and the one or more second blockchain addresses, means for transmitting, to the blockchain wallet application, a permissions payload comprising one or more parameters defining usage of the temporary key pair by the client application and an indication a public key of the temporary key pair, means for receiving the permissions payload that is signed using a private key associated with the first blockchain address, and means for transmitting, to one or more servers associated with the blockchain wallet application, a request to transfer an amount of the crypto tokens between the first blockchain address and the one or more second blockchain addresses via a blockchain network, wherein the request to transfer is signed using a private key of the temporary key pair.

A non-transitory computer-readable medium storing code for digital token management is described. The code may include instructions executable by one or more processors to receive, at a client application, a user input to provide permissions to the client application associated with transferring crypto tokens between a first blockchain address associated with a blockchain wallet application and one or more second blockchain addresses, generate, at the client application after receiving the user input, a temporary key pair that is associated with transferring tokens between the first blockchain address associated with the blockchain wallet application and the one or more second blockchain addresses, transmit, to the blockchain wallet application, a permissions payload comprising one or more parameters defining usage of the temporary key pair by the client application and an indication a public key of the temporary key pair, receive the permissions payload that is signed using a private key associated with the first blockchain address, and transmit, to one or more servers associated with the blockchain wallet application, a request to transfer an amount of the crypto tokens between the first blockchain address and the one or more second blockchain addresses via a blockchain network, wherein the request to transfer is signed using a private key of the temporary key pair.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method for digital token management, comprising:
receiving, at a client application, user input to provide permissions to the client application associated with transferring crypto tokens between a first blockchain address associated with a blockchain wallet application and one or more second blockchain addresses;
obtaining, by the client application and after receiving the user input, a temporary key pair that is associated with transferring tokens between the first blockchain address associated with the blockchain wallet application and the one or more second blockchain addresses;
transmitting, by the client application and to the blockchain wallet application, a permissions payload comprising one or more parameters defining usage of the temporary key pair by the client application and an indication a public key of the temporary key pair;
receiving, by the client application based at least in part on transmitting the permissions payload to the blockchain wallet application, the permissions payload that is signed using a private key associated with the first blockchain address;
signing, by the client application with a private key of the temporary key pair and without prompting a user for further authentication, a request to transfer an amount of the crypto tokens between the first blockchain address and the one or more second blockchain addresses via a blockchain network, wherein the request to transfer the amount of the crypto tokens is in accordance with the one or more parameters defining the usage of the temporary key pair; and
transmitting, to one or more servers associated with the blockchain wallet application, the signed request to transfer the amount of the crypto tokens between the first blockchain address and the one or more second blockchain addresses via the blockchain network.

2. The method of claim 1, wherein obtaining the temporary key pair comprises:
generating the temporary key pair via a key service of the client application.

3. The method of claim 1, wherein obtaining the temporary key pair comprises:
transmitting, to a software development kit associated with the blockchain wallet application and installed by the client application, a request to generate the temporary key pair, wherein the software development kit generates and stores the temporary key pair.

4. The method of claim 1, wherein receiving the permissions payload comprises:
receiving, from a software development kit associated with the blockchain wallet application and installed by the client application, the permissions payload.

5. The method of claim 1, wherein transmitting the signed request to transfer comprises:
transmitting, to a software development kit associated with the blockchain wallet application and installed by the client application, the signed request to transfer, wherein the software development kit is configured to transfer the signed request to transfer to the one or more servers.

6. The method of claim 1, further comprising:
transmitting, to the one or more servers, a request to prepare call data indicating execution of a transaction that transfers the amount of the crypto tokens between the first blockchain address and the one or more second blockchain addresses; and
receiving, from the one or more servers after transmitting the request to prepare the call data, the prepared call data and a hash value associated with the prepared call data, wherein the request to transfer is signed based on a signature over the hash value using the private key of the temporary key pair.

7. The method of claim 1, wherein the one or more parameters comprise a duration for which the temporary key pair is valid, a threshold amount of crypto tokens that are approved for transfer between the first blockchain address and the one or more second blockchain addresses, the one or more second blockchain addresses via which transfer of crypto tokens is approved, a threshold quantity of requests to transfer the crypto tokens between the first blockchain address and the one or more second blockchain addresses that are approved, a type of crypto token that is approved for transfer between the first blockchain address and the one or more second blockchain addresses, or any combination thereof.

8. An apparatus for digital token management, comprising:
one or more memories storing processor-executable code; and
one or more processors coupled with the one or more memories and individually or collectively operable to execute the code to cause the apparatus to:
receive, at a client application, a user input to provide permissions to the client application associated with transferring crypto tokens between a first blockchain address associated with a blockchain wallet application and one or more second blockchain addresses;
obtain, by the client application and after receiving the user input, a temporary key pair that is associated with transferring tokens between the first blockchain address associated with the blockchain wallet application and the one or more second blockchain addresses;
transmit, by the client application and to the blockchain wallet application, a permissions payload comprising one or more parameters defining usage of the temporary key pair by the client application and an indication a public key of the temporary key pair;
receive, by the client application based at least in part on transmitting the permissions payload to the blockchain wallet application, the permissions payload that is signed using a private key associated with the first blockchain address;
sign, by the client application with a private key of the temporary key pair and without prompting a user for further authentication, a request to transfer an amount of the crypto tokens between the first blockchain address and the one or more second blockchain addresses via a blockchain network, wherein the request to transfer the amount of the crypto tokens is in accordance with the one or more parameters defining the usage of the temporary key pair; and
transmit the signed request to transfer the amount of the crypto tokens between the first blockchain address and the one or more second blockchain addresses via the blockchain network.

9. The apparatus of claim 8, wherein, to obtain the temporary key pair, the one or more processors are individually or collectively operable to execute the code to cause the apparatus to:
generate the temporary key pair via a key service of the client application.

10. The apparatus of claim 8, wherein, to obtain the temporary key pair, the one or more processors are individually or collectively operable to execute the code to cause the apparatus to:
transmit, to a software development kit associated with the blockchain wallet application and installed by the client application, a request to generate the temporary key pair, wherein the software development kit generates and stores the temporary key pair.

11. The apparatus of claim 8, wherein, to receive the permissions payload, the one or more processors are individually or collectively operable to execute the code to cause the apparatus to:
receive, from a software development kit associated with the blockchain wallet application and installed by the client application, the permissions payload.

12. The apparatus of claim 8, wherein, to transmit the signed request to transfer, the one or more processors are individually or collectively operable to execute the code to cause the apparatus to:
transmit, to a software development kit associated with the blockchain wallet application and installed by the client application, the signed request to transfer, wherein the software development kit is configured to transfer the signed request to transfer to one or more servers.

13. The apparatus of claim 8, wherein the one or more processors are individually or collectively operable to execute the code to cause the apparatus to:
transmit, to one or more servers, a request to prepare call data indicating execution of a transaction that transfers the amount of the crypto tokens between the first blockchain address and the one or more second blockchain addresses; and
receive, from the one or more servers after transmitting the request to prepare the call data, the prepared call data and a hash value associated with the prepared call data, wherein the request to transfer is signed based on a signature over the hash value using the private key of the temporary key pair.

14. The apparatus of claim 8, wherein the one or more parameters comprise a duration for which the temporary key pair is valid, a threshold amount of crypto tokens that are approved for transfer between the first blockchain address and the one or more second blockchain addresses, the one or more second blockchain addresses via which transfer of crypto tokens is approved, a threshold quantity of requests to transfer the crypto tokens between the first blockchain address and the one or more second blockchain addresses that are approved, a type of crypto token that is approved for transfer between the first blockchain address and the one or more second blockchain addresses, or any combination thereof.

15. A non-transitory computer-readable medium storing code for digital token management, the code comprising instructions executable by one or more processors to:
receive, at a client application, user input to provide permissions to the client application associated with transferring crypto tokens between a first blockchain address associated with a blockchain wallet application and one or more second blockchain addresses;
generate, by the client application and at the client application after receiving the user input, a temporary key pair that is associated with transferring tokens between the first blockchain address associated with the blockchain wallet application and the one or more second blockchain addresses;
transmit, by the client application and to the blockchain wallet application, a permissions payload comprising one or more parameters defining usage of the temporary key pair by the client application and an indication a public key of the temporary key pair;
receive, by the client application based at least in part on transmitting the permissions payload to the blockchain wallet application, the permissions payload that is signed using a private key associated with the first blockchain address;
sign, by the client application with a private key of the temporary key pair and without prompting a user for further authentication, a request to transfer an amount of the crypto tokens between the first blockchain address and the one or more second blockchain addresses via a blockchain network, wherein the request to transfer the amount of the crypto tokens is in accordance with the one or more parameters defining the usage of the temporary key pair; and
transmit, to one or more servers associated with the blockchain wallet application, the signed request to transfer the amount of the crypto tokens between the first blockchain address and the one or more second blockchain addresses via the blockchain network.

16. The non-transitory computer-readable medium of claim 15, wherein, to receive the permissions payload, the instructions are executable by one or more processors to:
receive, from a software development kit associated with the blockchain wallet application and installed by the client application, the permissions payload.

17. The non-transitory computer-readable medium of claim 15, wherein, to transmit the signed request to transfer, the instructions are executable by one or more processors to:
transmit, to a software development kit associated with the blockchain wallet application and installed by the client application, the signed request to transfer, wherein the software development kit is configured to transfer the signed request to transfer to the one or more servers.

18. The non-transitory computer-readable medium of claim 15, wherein the instructions are further executable by one or more processors to:
transmit, to the one or more servers, a request to prepare call data indicating execution of a transaction that transfers the amount of the crypto tokens between the first blockchain address and the one or more second blockchain addresses; and
receive, from the one or more servers after transmitting the request to prepare the call data, the prepared call data and a hash value associated with the prepared call data, wherein the request to transfer is signed based on a signature over the hash value using the private key of the temporary key pair.

19. The non-transitory computer-readable medium of claim 15, wherein the one or more parameters comprise a duration for which the temporary key pair is valid, a threshold amount of crypto tokens that are approved for transfer between the first blockchain address and the one or more second blockchain addresses, or any combination thereof.

20. The non-transitory computer-readable medium of claim 15, wherein the one or more parameters comprise the one or more second blockchain addresses via which transfer of crypto tokens is approved, a threshold quantity of requests to transfer the crypto tokens between the first blockchain address and the one or more second blockchain addresses that are approved, a type of crypto token that is approved for transfer between the first blockchain address and the one or more second blockchain addresses, or any combination thereof.
